(19) United States
(12) Patent Application Publication
(10) Pub. No.: US 2019/0088265 A1
(43) Pub. Date: Mar. 21, 2019

(54) FILE GENERATION DEVICE AND FILE GENERATION METHOD

(71) Applicant: SONY CORPORATION, TOKYO (JP)

(72) Inventors: MITSUHIRO HIRABAYASHI, TOKYO (JP); TORU CHINEN, KANAGAWA (JP)

(21) Appl. No.: 16/086,469

(22) PCT Filed: Mar. 14, 2017
(86) PCT No.: PCT/JP2017/010105

§ 371 Date: Sep. 19, 2018

(30) Foreign Application Priority Data
Mar. 28, 2016 (JP) 2016-063223

(51) Int. Cl. G10L 19/00; H04N 19/115; H04N 19/157; H04N 19/184; G10L 19/16; G06F 16/11

(52) U.S. Cl. CPC G10L 19/0017; H04N 19/115; G06F 16/122; H04N 19/184; G10L 19/167; H04N 19/157

(57) ABSTRACT

The present disclosure relates to a file generation device and a file generation method which enable acquisition of a video stream having an optimum bit rate when acquiring an audio stream encoded by a lossless compression technique and a video stream. An MPD file generation unit generates AveBandwidth and DurationForAveBandwidth representing the bit rate of an audio stream encoded by a lossless DSD technique. The present disclosure can be applied to, for example, a file generation device or the like that generates a segment file of moving image content by a technique conforming to MPEG-DASH.

### TECHNICAL FIELD

The present disclosure relates to a file generation device and a file generation method and, in particular, to a file generation device and a file generation method which enable acquisition of a video stream having an optimum bit rate when acquiring an audio stream encoded by a lossless compression technique and a video stream.

### BACKGROUND ART

In recent years, the mainstream of streaming service on the Internet is over-the-top video (OTT-V). Moving picture experts group phase—dynamic adaptive streaming over HTTP (MPEG-DASH) is beginning to spread as a basic technology thereof (for example, refer to Non-Patent Document 1).

In MPEG-DASH, adaptive streaming distribution is implemented in such a manner that a distribution server prepares moving image data groups having different bit rates for one piece of moving image content and a reproduction terminal requests a moving image data group having an optimum bit rate in accordance with the condition of a transfer line.

In addition, in the present-day MPEG-DASH, an encoding technique capable of predicting a bit rate beforehand is assumed as an encoding technique for moving image content. Specifically, for example, a lossy compression technique is assumed as an encoding technique for the audio stream, in which an audio digital signal analog-digital (A/D)-converted by a pulse code modulation (PCM) technique is encoded such that underflow or overflow is not produced in a fixed-size buffer. Therefore, the bit rate of the moving image content to be acquired is decided on the basis of the predicted bit rate and the network band of the moving image content.

Meanwhile, in recent years, high-resolution audio of higher sound quality than the sound source of compact disc (CD) has attracted attention. The A/D conversion technique for the high-resolution audio includes a direct stream digital (DSD) technique and the like. The DSD technique is a technique adopted as a recording and reproducing technique for a Super Audio CD (SA-CD) and is a technique based on one-bit digital sigma modulation. Specifically, in the DSD technique, information regarding an audio analog signal is expressed with the density of change points between “1” and “0” using the time axis. Therefore, it is possible to implement high-resolution recording and reproduction independent of the bit depth.

In the DSD technique, however, the patterns of “1” and “0” of the audio digital signal change in accordance with the waveform of the audio analog signal. Therefore, in a lossless DSD technique or the like in which the audio digital signal subjected to the A/D conversion by the DSD technique is losslessly compressed and encoded on the basis of the patterns of “1” and “0”, the bit production amount of the audio digital signal after encoding fluctuates in accordance with the waveform of the audio analog signal. Accordingly, it is difficult to predict the bit rate beforehand.

### CITATION LIST

### Non-Patent Document

Non-patent Document 1: Dynamic Adaptive Streaming over HTTP (MPEG-DASH) (URL: http://mpeg.chiariglione.org/standards/mpeg-dash/media-presentation-description-and-segment-formats/text-isoiec-23009-12012-dam-1)

### SUMMARY OF THE INVENTION

### Problems to be Solved by the Invention

For the reason above, in the present-day MPEG-DASH, in a case where an audio stream encoded by a lossless compression technique such as the lossless DSD technique for which the bit rate cannot be predicted, and a video stream are acquired, the bit rate of the video stream to be acquired must be selected on the basis of the network band and the maximum value of values that can be taken as the bit rate of the audio stream. Accordingly, it is difficult to acquire a video stream having an optimum bit rate.

The present disclosure has been made in view of the above circumstances and it is an object of the present disclosure to make it possible to acquire a video stream having an optimum bit rate when acquiring an audio stream encoded by a lossless compression technique and a video stream.

### Solutions to Problems

A file generation device according to an aspect of the present disclosure is a file generation device including a generation unit that generates bit rate information representing a bit rate of an audio stream encoded by a lossless compression technique.

A file generation method according to an aspect of the present disclosure corresponds to the file generation device according to one aspect of the present disclosure.

In one aspect of the present disclosure, bit rate information representing a bit rate of an audio stream encoded by a lossless compression technique is generated.

Note that the file generation device of one aspect of the present disclosure can be implemented by causing a computer to execute a program.

In addition, in order to implement the file generation device of one aspect of the present disclosure, the program to be executed by the computer can be provided by being transferred via a transfer medium or by being recorded on a recording medium.

### Effects of the Invention

According to one aspect of the present disclosure, it is possible to acquire a video stream having an optimum bit rate when acquiring an audio stream encoded by a lossless compression technique and a video stream.

Note that the effects described herein are not necessarily limited and any effects described in the present disclosure may be applied.

### BRIEF DESCRIPTION OF DRAWINGS

FIG. 1 is a diagram for explaining an outline of an information processing system according to a first embodiment to which the present disclosure is applied.

FIG. 2 is a diagram for explaining a DSD technique.

FIG. 3 is a block diagram illustrating a configuration example of a file generation device in FIG. 1.

FIG. 4 is a diagram illustrating a first description example of a media presentation description (MPD) file.

FIG. 5 is a diagram illustrating a second description example of the MPD file.

FIG. 6 is a flowchart for explaining a file generation process in the first embodiment.

FIG. 7 is a block diagram illustrating a configuration example of a streaming reproduction unit.

FIG. 8 is a diagram illustrating an example of an actual bit rate of an audio stream.

FIG. 9 is a flowchart for explaining a reproduction process in the first embodiment.

FIG. 10 is a diagram illustrating a first description example of the MPD file in a second embodiment.

FIG. 11 is a diagram illustrating a second description example of the MPD file in the second embodiment.

FIG. 12 is a flowchart for explaining a file generation process in the second embodiment.

FIG. 13 is a flowchart for explaining an MPD file update process in the second embodiment.

FIG. 14 is a flowchart for explaining a reproduction process in the second embodiment.

FIG. 15 is a diagram illustrating a configuration example of a media segment file in a third embodiment.

FIG. 16 is a diagram illustrating a description example of an emsg box in FIG. 15.

FIG. 17 is a flowchart for explaining a file generation process in the third embodiment.

FIG. 18 is a diagram illustrating a description example of the emsg box in a fourth embodiment.

FIG. 19 is a flowchart for explaining a file generation process in the fourth embodiment.

FIG. 20 is a diagram illustrating a description example of the emsg box in a fifth embodiment.

FIG. 21 is a diagram illustrating a description example of the MPD file in a sixth embodiment.

FIG. 22 is a diagram illustrating a first description example of the MPD file in a seventh embodiment.

FIG. 23 is a diagram illustrating a second description example of the MPD file in the seventh embodiment.

FIG. 24 is a diagram illustrating a configuration example of the media segment file in the seventh embodiment.

FIG. 25 is a block diagram illustrating a configuration example of a lossless compression encoding unit.

FIG. 26 is a diagram illustrating an example of a data production count table.

FIG. 27 is a diagram illustrating an example of a conversion table table1.

FIG. 28 is a block diagram illustrating a configuration example of a lossless compression decoding unit.

FIG. 29 is a block diagram illustrating a configuration example of hardware of a computer.

### MODE FOR CARRYING OUT THE INVENTION

Modes for carrying out the present disclosure (hereinafter, referred to as embodiments) will be described below. Note that the description will be given in the following order.

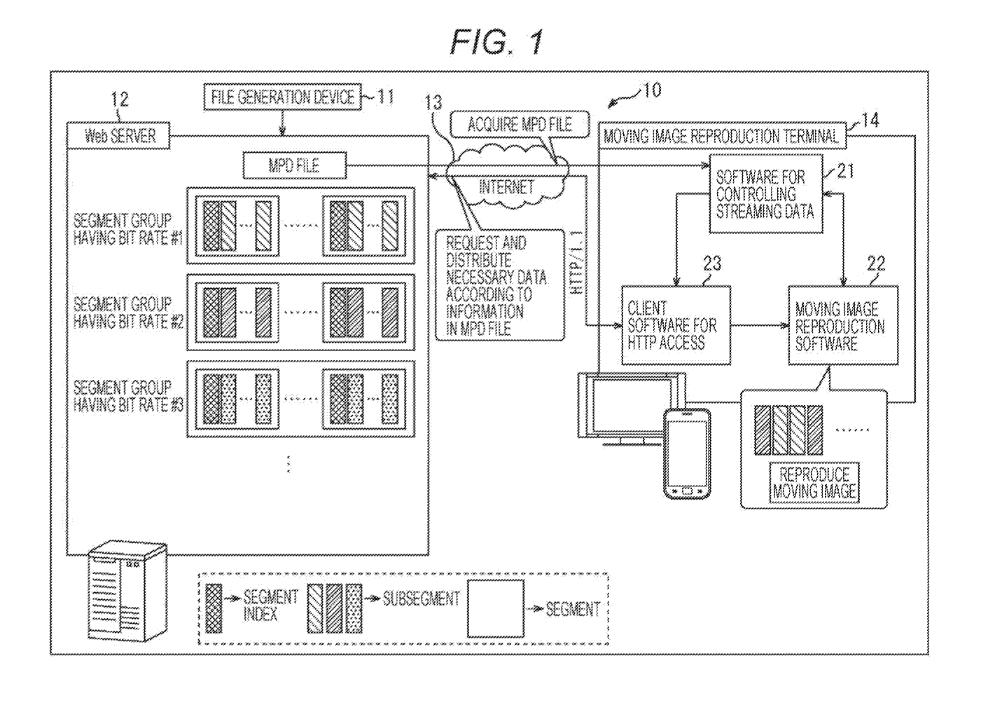

1. First Embodiment: Information Processing System (FIGS. 1 to 9)

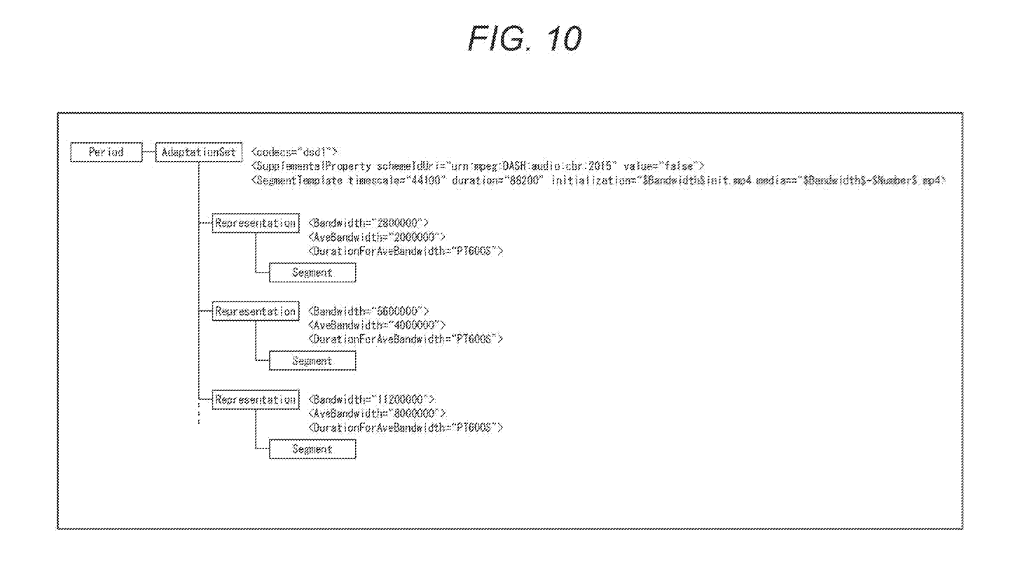

2. Second Embodiment: Information Processing System (FIGS. 10 to 14)

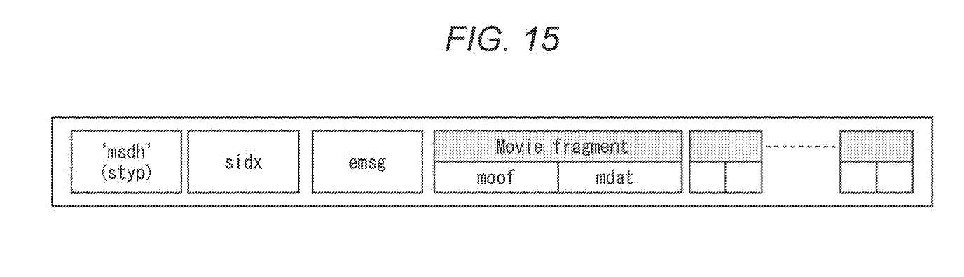

3. Third Embodiment: Information Processing System (FIGS. 15 to 17)

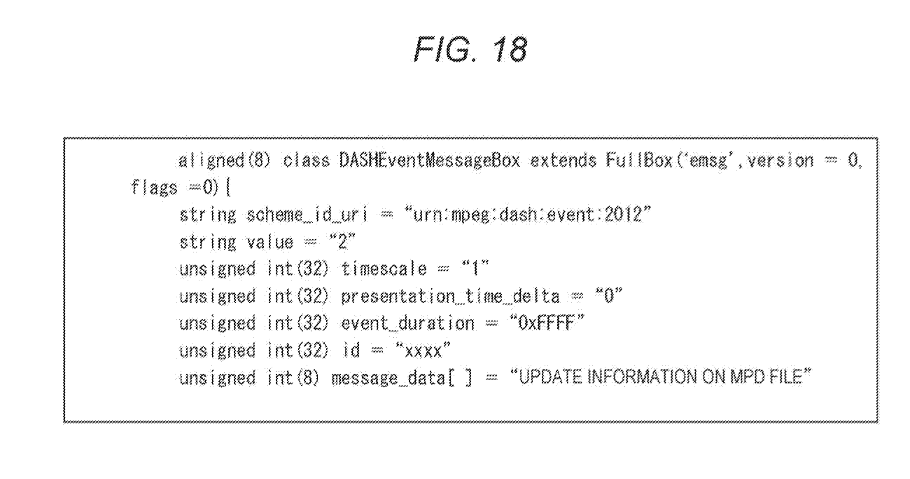

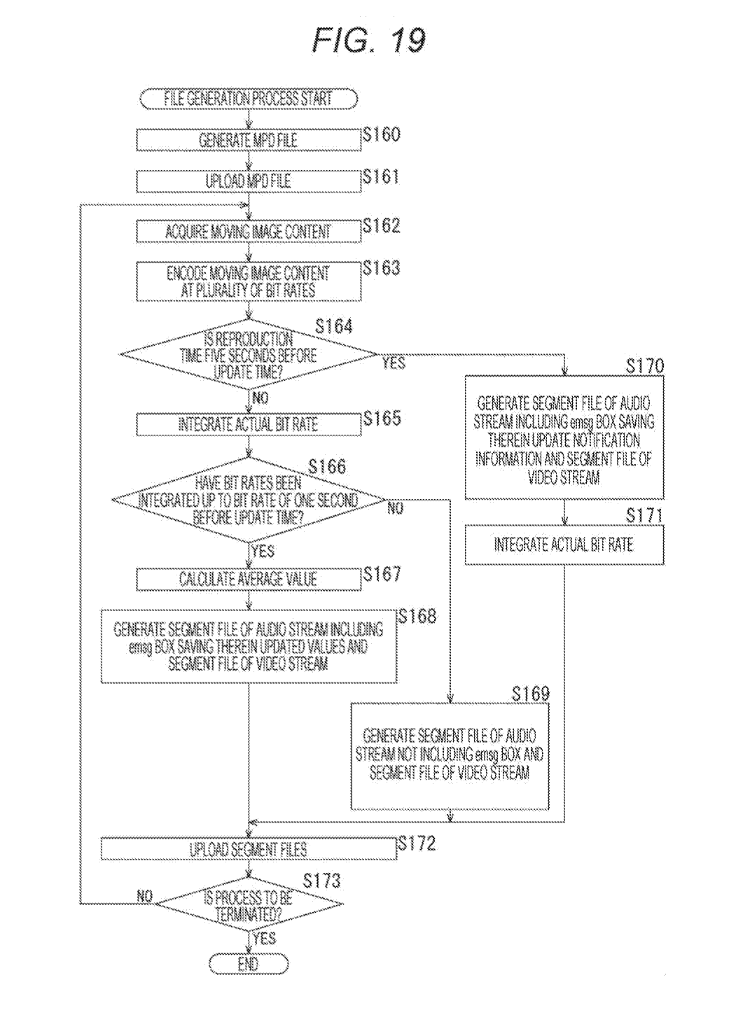

4. Fourth Embodiment: Information Processing System (FIGS. 18 and 19)

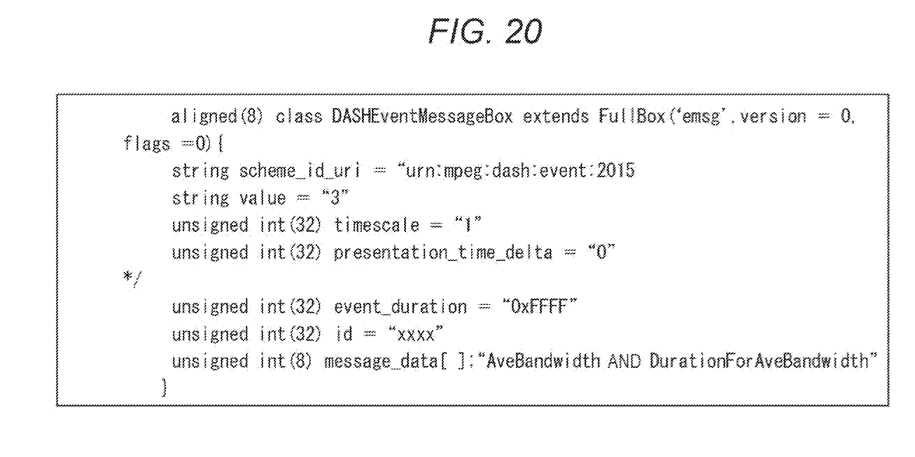

5. Fifth Embodiment: Information Processing System (FIG. 20)

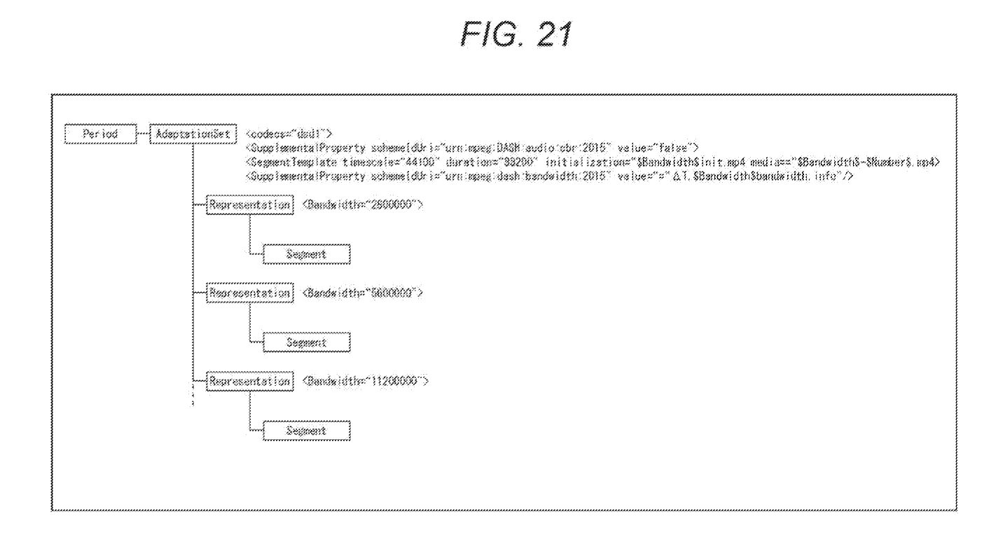

6. Sixth Embodiment: Information Processing System (FIG. 21)

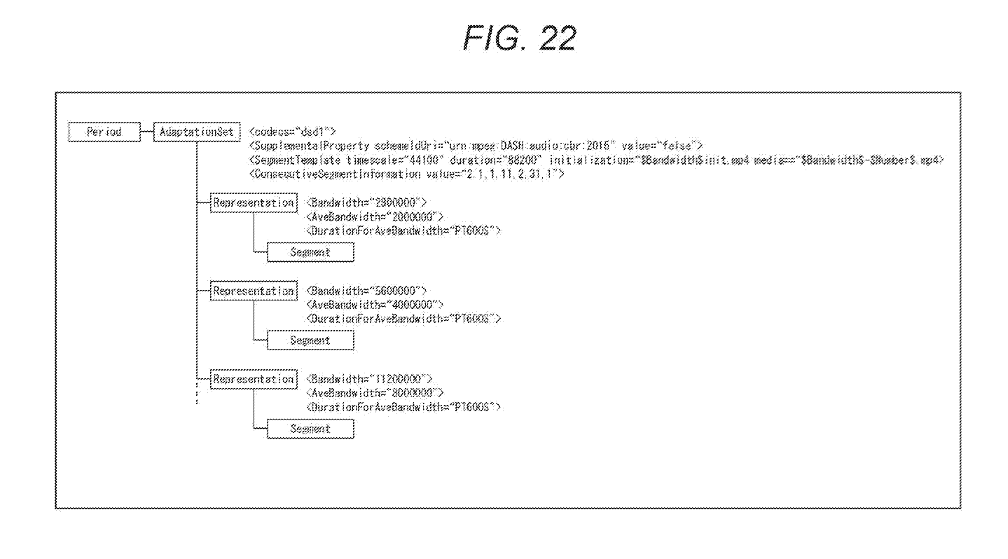

7. Seventh Embodiment: Information Processing System (FIGS. 22 to 24)

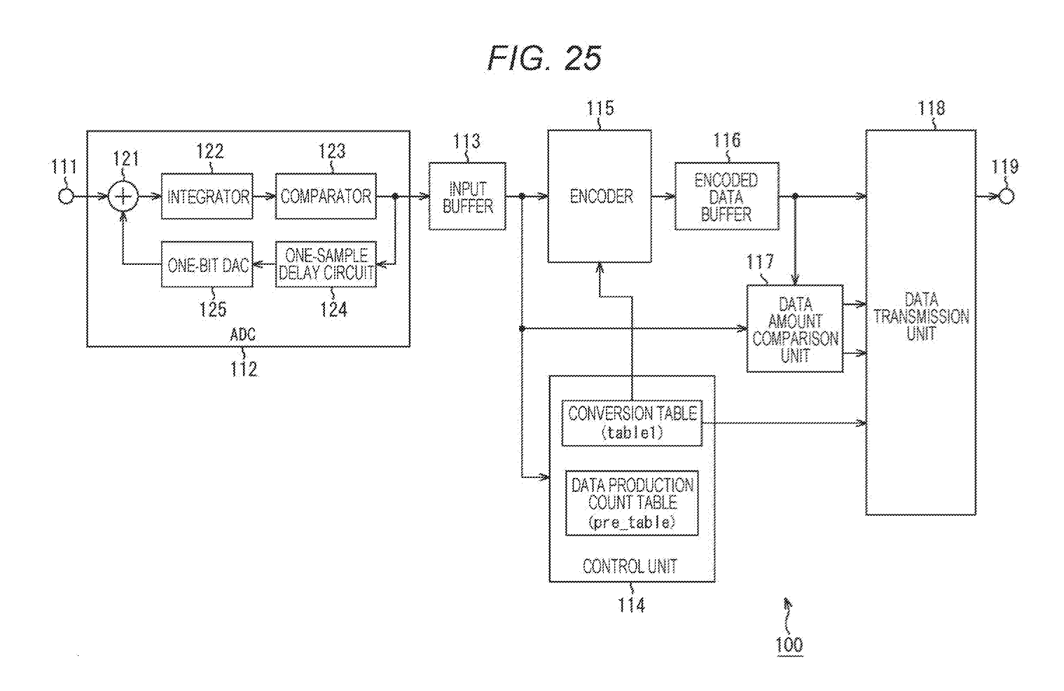

8. Explanation of Lossless DSD Technique (FIGS. 25 to 28)

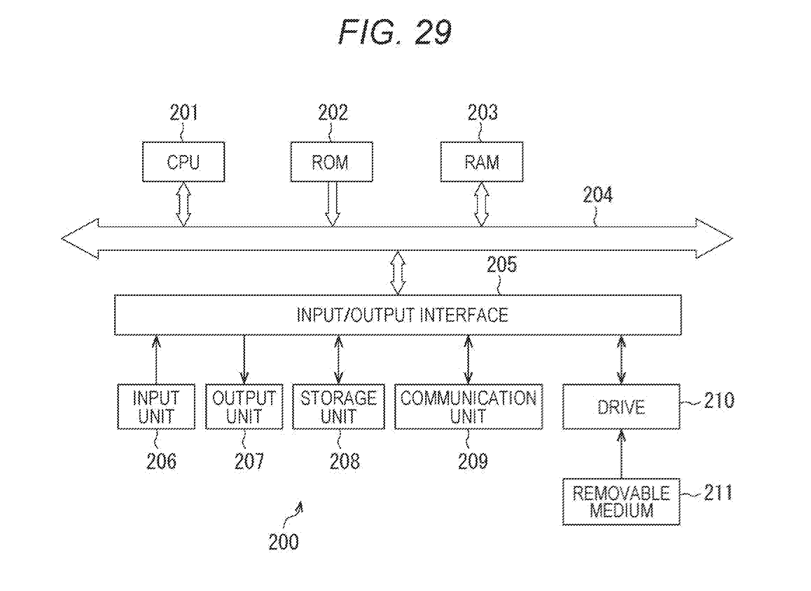

9. Eighth Embodiment: Computer (FIG. 29)

### First Embodiment

(Outline of Information Processing System of First Embodiment)

FIG. 1 is a diagram for explaining an outline of an information processing system according to a first embodiment to which the present disclosure is applied.

The information processing system 10 in FIG. 1 is configured by connecting a Web server 12 as a DASH server connected to a file generation device 11 and a moving image reproduction terminal 14 as a DASH client via the Internet 13.

In the information processing system 10, the Web server 12 live-distributes a file of moving image content generated by the file generation device 11 to the moving image reproduction terminal 14 by a technique conforming to MPEG-DASH.

Specifically, the file generation device 11 A/D-converts a video analog signal and an audio analog signal of the moving image content to generate a video digital signal and an audio digital signal. Then, the file generation device 11 encodes the video digital signal, the audio digital signal, and other signals of the moving image content at a plurality of bit rates by a predetermined encoding technique to generate an encoded stream. It is assumed in this example that the encoding technique for the audio digital signal is a lossless DSD technique or a moving picture experts group phase 4 (MPEG-4) technique. The MPEG-4 technique is a technique of lossily compressing an audio digital signal A/D-converted by a PCM technique such that underflow or overflow is not produced in a fixed-size buffer.

For each bit rate, the file generation device 11 transforms the encoded stream that has been generated into a file in time units called segments from several seconds to about ten seconds. The file generation device 11 uploads a segment file and the like generated as a result of the transformation to the Web server 12.

The file generation device 11 also generates a media presentation description (MPD) file (management file) that manages the moving image content. The file generation device 11 uploads the MPD file to the Web server 12.

The Web server 12 saves therein the segment file and the MPD file uploaded from the file generation device 11. In response to a request from the moving image reproduction terminal 14, the Web server 12 transmits the saved segment file and MPD file to the moving image reproduction terminal 14.

The moving image reproduction terminal 14 (reproduction device) executes software for controlling streaming data (hereinafter referred to as control software) 21, moving image reproduction software 22, client software for hypertext transfer protocol (HTTP) access (hereinafter referred to as access software) 23, and the like.

The control software 21 is software that controls data to be streamed from the Web server 12. Specifically, the control software 21 causes the moving image reproduction terminal 14 to acquire the MPD file from the Web server 12.

In addition, the control software 21 instructs the access software 23 on a transmission request for an encoded stream of a segment file to be reproduced, on the basis of the MPD file, reproduction time information representing the reproduction time designated by the moving image reproduction software 22, and the like, and the network band of the Internet 13.

The moving image reproduction software 22 is software that reproduces the encoded stream acquired from the Web server 12 via the Internet 13. Specifically, the moving image reproduction software 22 designates the reproduction time information to the control software 21. In addition, when receiving a notification of start of reception from the access software 23, the moving image reproduction software 22 decodes the encoded stream received by the moving image reproduction terminal 14. The moving image reproduction software 22 outputs a video digital signal and an audio digital signal obtained as a result of decoding.

The access software 23 is software that controls communication with the Web server 12 via the Internet 13 using HTTP. Specifically, in response to the instruction from the control software 21, the access software 23 causes the moving image reproduction terminal 14 to transmit the transmission request for the encoded stream of the segment file to be reproduced. In response to this transmission request, the access software 23 also causes the moving image reproduction terminal 14 to start receiving the encoded stream being transmitted from the Web server 12 and supplies a notification of start of reception to the moving image reproduction software 22.

(Explanation of DSD Technique)

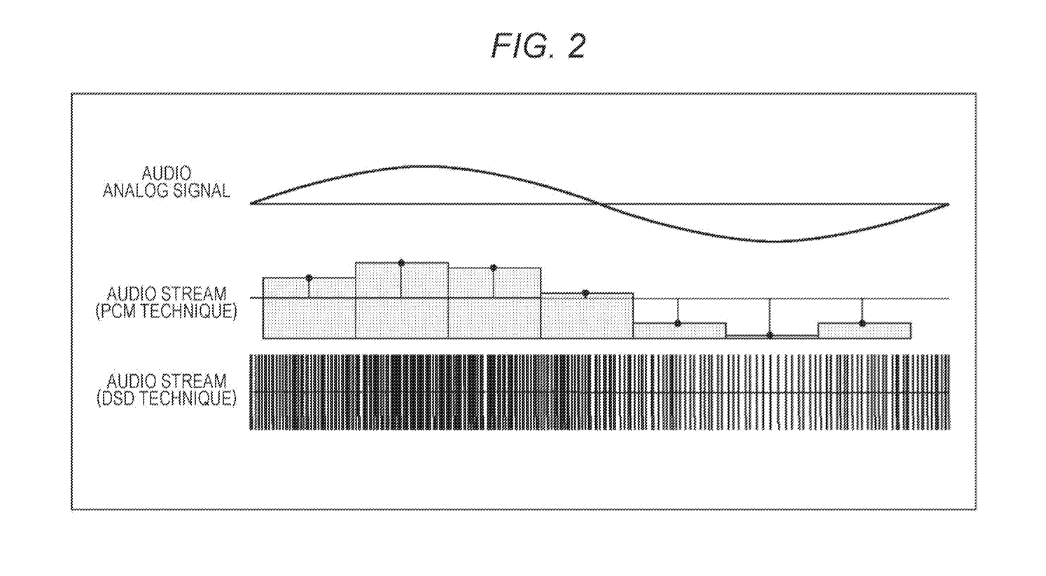

FIG. 2 is a diagram for explaining a DSD technique.

In FIG. 2, the horizontal axis represents time and the vertical axis represents the value of each signal.

In the example in FIG. 2, the waveform of the audio analog signal is a sine wave. In a case where such an audio analog signal is A/D-converted by the PCM technique, as illustrated in FIG. 2, the value of the audio analog signal at each sampling time is converted into an audio digital signal of a fixed number of bits according to that value.

In contrast to this, in a case where the audio analog signal is A/D-converted by the DSD technique, the value of the audio analog signal at each sampling time is converted into an audio digital signal with the density of change points between “0” and “1” according to that value. Specifically, the larger the value of the audio analog signal, the higher the density of change points of the audio digital signal, while the smaller the value of the audio analog signal, the lower the density of change points of the audio digital signal. That is, the patterns of “0” and “1” of the audio digital signal change in accordance with the value of the audio analog signal.

Therefore, the bit production amount of the encoded stream obtained by encoding this audio digital signal by a lossless DSD technique in which lossless compression encoding is conducted on the basis of the patterns of “0” and “1” fluctuates in accordance with the waveform of the audio analog signal. Accordingly, it is difficult to predict the bit rate beforehand.

(Configuration Example of File Generation Device)

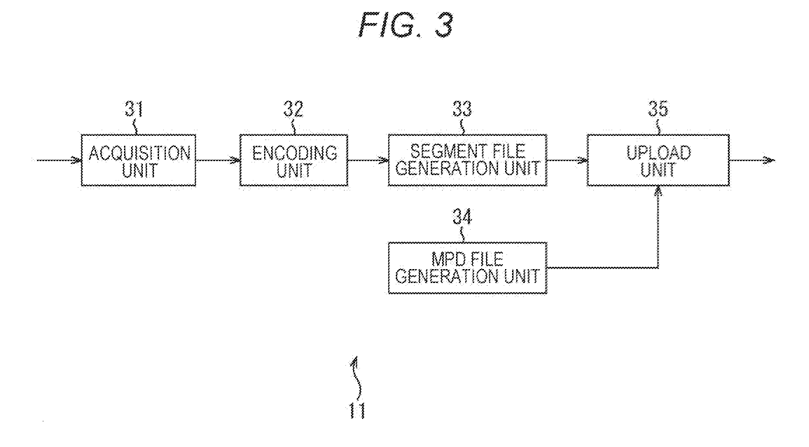

FIG. 3 is a block diagram illustrating a configuration example of the file generation device in FIG. 1.

The file generation device 11 in FIG. 3 is constituted by an acquisition unit 31, an encoding unit 32, a segment file generation unit 33, an MPD file generation unit 34, and an upload unit 35.

The acquisition unit 31 of the file generation device 11 acquires the video analog signal and the audio analog signal of the moving image content to A/D-convert. The acquisition unit 31 supplies the encoding unit 32 with signals such as a video digital signal and an audio digital signal obtained as a result of the A/D conversion and a signal of the moving image content acquired additionally. The encoding unit 32 encodes each of the signals of the moving image content supplied from the acquisition unit 31 at a plurality of bit rates and generates an encoded stream. The encoding unit 32 supplies the generated encoded stream to the segment file generation unit 33.

The segment file generation unit 33 (generation unit) transforms the encoded stream supplied from the encoding unit 32 into a file in units of segments for each bit rate. The segment file generation unit 33 supplies a segment file generated as a result of the transformation to the upload unit 35.

The MPD file generation unit 34 generates an MPD file including information indicating that the encoding technique for the audio digital signal is the lossless DSD technique, the maximum bit rate of an audio stream which is an encoded stream of the audio digital signal, and the bit rate of a video stream which is an encoded stream of the video digital signal. Note that the maximum bit rate means the maximum value of values that can be taken as the bit rate. The MPD file generation unit 34 supplies the MPD file to the upload unit 35.

The upload unit 35 uploads the segment file supplied from the segment file generation unit 33 and the MPD file supplied from the MPD file generation unit 34 to the Web server 12 in FIG. 1.

(First Description Example of MPD File)

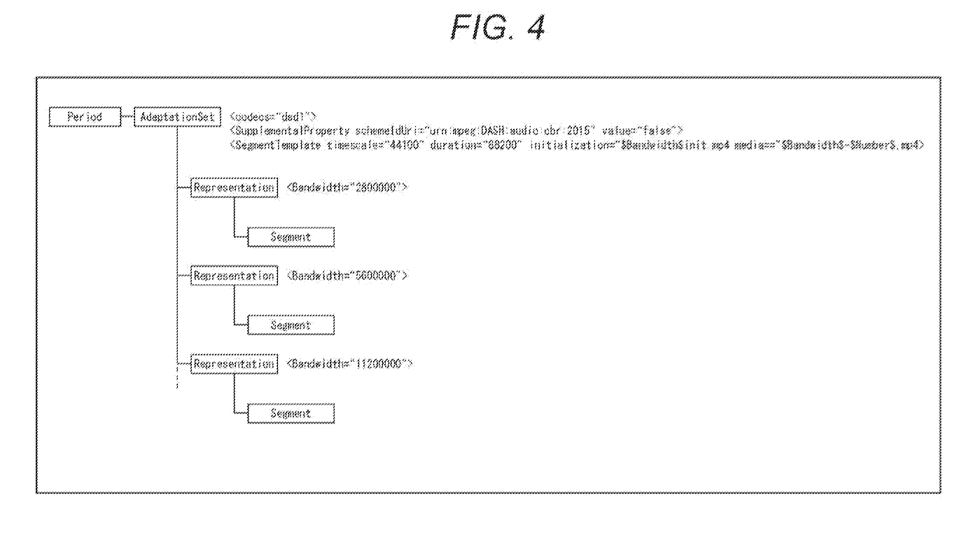

FIG. 4 is a diagram illustrating a first description example of the MPD file.

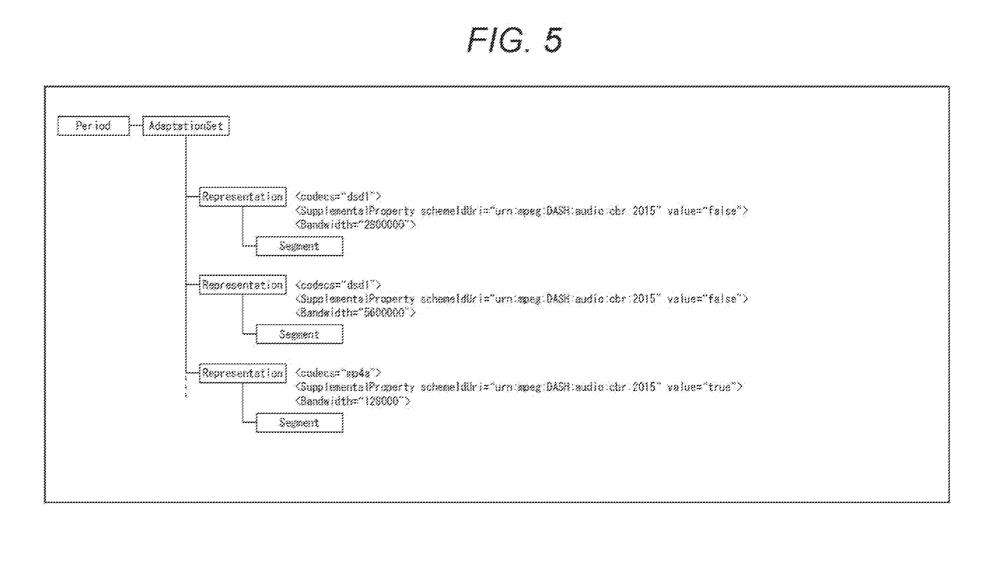

Note that, for convenience of explanation, FIG. 4 illustrates only descriptions that manage the segment file of the audio stream, among the descriptions in the MPD file. This similarly applies also to FIGS. 5, 10, 11, 22, and 23 to be described later.

In the MPD file, information such as the encoding technique and the bit rate of the moving image content, the size of the image, and the language of the speech is layered and described in an extensible markup language (XML) format.

As illustrated in FIG. 4, the MPD file hierarchically includes elements such as a period (Period), an adaptation set (AdaptationSet), representation (Representation), and segment information (Segment).

In the MPD file, the moving image content managed by this MPD file is divided into a predetermined time range (for example, units such as a program and a commercial (CM)). The period element is described for each divided piece of the moving image content. The period element has information such as the reproduction start time of the moving image content, the uniform resource locator (URL) of the Web server 12 that saves therein the segment file of the moving image content, and MinBufferTime, as information common to the corresponding moving image content. MinBufferTime is information indicating the buffer time of a virtual buffer and is set to 0 in the example in FIG. 4.

The adaptation set element is included in the period element and groups the representation elements corresponding to the segment file group of the same encoded stream of the moving image content corresponding to this period element. For example, the representation elements are grouped depending on the type of data of the corresponding segment file group. In the example in FIG. 4, three representation elements corresponding to respective segment files of three types of audio streams having different bit rates are grouped by one adaptation set element.

The adaptation set element has uses such as media class, language, subtitle, or dubbing, maxBandwidth which is the maximum value of the bit rate, MinBandwidth which is the minimum value of the bit rate, and the like, as information common to group for the corresponding segment file group.

Note that, in the example in FIG. 4, all encoding techniques for three types of audio streams having different bit rates employ the lossless DSD technique. Therefore, the adaptation set element of the segment files of the audio streams also has <codecs=“dsd1”> indicating that the encoding technique for the audio stream is the lossless DSD technique, as information common to the group.

In addition, the adaptation set element also has <SupplementalProperty schemeIdUri=“urn:mpeg:DASH:audio:cbr:2015”> which is a descriptor indicating whether the encoding technique for the audio streams is a technique that ensures underflow or overflow not to be produced in a fixed-size buffer during encoding, such as the MPEG-4 technique (hereinafter referred to as fixed technique).

The value (value) of <SupplementalProperty schemeIdUri=“urn:mpeg:DASH:audio:cbr:2015”> is set to “true” in the case of indicating that the encoding technique for the audio streams is the fixed technique and is set to “false” in the case of indicating that the encoding technique is not the fixed technique. Therefore, in the example in FIG. 4, the value of <SupplementalProperty schemeIdUri=“urn:mpeg:DASH:audio:cbr:2015”> is “false”.

The adaptation set element also has a SegmentTemplate indicating the length of the segment and the file name rule of the segment file. In the SegmentTemplate, timescale, duration, initialization, and media are described.

timescale is a value representing one second and duration is the value of the segment length when timescale is assumed as one second. In the example in FIG. 4, timescale has 44100 and duration has 88200. Therefore, the segment length is two seconds.

initialization is information indicating the rule of the name of an initialization segment file among the segment files of the audio stream. In the example in FIG. 4, initialization has “$Bandwidth$init.mp4”. Therefore, the name of the initialization segment file of the audio streams is obtained by adding init to Bandwidth included in the representation element.

In addition, media is information indicating the rule of the name of a media segment file among the segment files of the audio stream. In the example in FIG. 4, media has “$Bandwidth$-$Number$.mp4”. Therefore, the names of the media segment files of the audio stream are obtained by adding “-” to Bandwidth included in the representation element and adding sequential numbers.

The representation element is included in the adaptation set element grouping this representation element and is described for each segment file group of the same encoded stream of the moving image content corresponding to the upper layer period element. The representation element has Bandwidth indicating the bit rate, the size of the image, and the like, as information common to the corresponding segment file group.

Note that, in a case where the encoding technique is the lossless DSD technique, the actual bit rate of the audio stream is unpredictable. Therefore, in the representation element corresponding to the audio stream, the maximum bit rate of the audio stream is described as the bit rate common to the corresponding segment file group.

In the example in FIG. 4, the maximum bit rates of the three types of audio streams are 2.8 Mbps, 5.6 Mbps, and 11.2 Mbps. Therefore, for Bandwidths of the respective three representation elements, 2800000, 5600000, and 11200000 are employed as Bandwidths. In addition, MinBandwidth of the adaptation set element is 2800000 and maxBandwidth thereof is 11200000.

The segment information element is included in the representation element and has information relating to each segment file of the segment file group corresponding to this representation element.

As described above, in a case where the encoding technique for the audio stream is the lossless DSD technique, the maximum bit rate of the audio stream is described in the MPD file. Therefore, by acquiring the audio stream and the video stream on the assumption that the bit rate of the audio stream is the maximum bit rate, the moving image reproduction terminal 14 can reproduce the streams without interruption. However, in a case where the actual bit rate of the audio stream is smaller than the maximum bit rate, waste is produced in the band allocated to the audio stream.

Note that, in the example in FIG. 4, <codecs=“dsd1”> and <SupplementalProperty schemeIdUri=“urn:mpeg:DASH:audio:cbr:2015” value=“false”> are described in the adaptation set element but may be described in each representation element.

(Second Description Example of MPD File)

FIG. 5 is a diagram illustrating a second description example of the MPD file.

In the example in FIG. 5, the encoding technique for two types of audio streams among three types of audio streams having different bit rates is the lossless DSD technique but the encoding technique for one type of audio stream is the MPEG-4 technique.

Therefore, in the MPD file in FIG. 5, the adaptation set element does not have <codecs=“dsd1”> and <SupplementalProperty schemeIdUri=“urn:mpeg:DASH:audio:cbr:2015” value=“false”>. Instead, the representation set element has information indicating the encoding technique for the audio stream and <SupplementalProperty schemeIdUri=“urn:mpeg:DASH:audio:cbr:2015”>.

Specifically, in the example in FIG. 5, the encoding technique for the audio stream corresponding to the first representation set element is the lossless DSD technique and the maximum bit rate is 2.8 Mbps. Therefore, the first representation set element has <codecs=“dsd1”>, <SupplementalProperty schemeIdUri=“urn:mpeg:DASH:audio:cbr:2015” value=“false”>, and 2800000 as Bandwidth.

In addition, the encoding technique for the audio stream corresponding to the second representation set element is the lossless DSD technique and the maximum bit rate is 5.6 Mbps. Therefore, the second representation set element has <codecs=“dsd1”>, <SupplementalProperty schemeIdUri=“urn:mpeg:DASH:audio:cbr:2015” value=“false”>, and 5600000 as Bandwidth.

Furthermore, the encoding technique for the audio stream corresponding to the third representation set element is the MPEG-4 technique and the actual bit rate is 128 kbps. Therefore, the first representation set element has <codecs=“mp4a”>, <SupplementalProperty schemeIdUri=“urn:mpeg:DASH:audio:cbr:2015” value=“true”>, and 128000 as Bandwidth. Note that <codecs=“mp4a”> is information indicating that the encoding technique for the audio stream is the MPEG-4 technique.

Additionally, the MPD files in FIGS. 4 and 5 are configured such that <codecs=“dsd1”> and <SupplementalProperty schemeIdUri=“urn:mpeg:DASH:audio:cbr:2015”> can be described in an MPD file for which a technique other than the fixed technique is not assumed as the encoding technique for the audio stream. Therefore, the MPD files in FIGS. 4 and 5 are compatible with an MPD file for which a technique other than the fixed technique is not assumed as the encoding technique for the audio stream.

(Explanation of Process of File Generation Device)

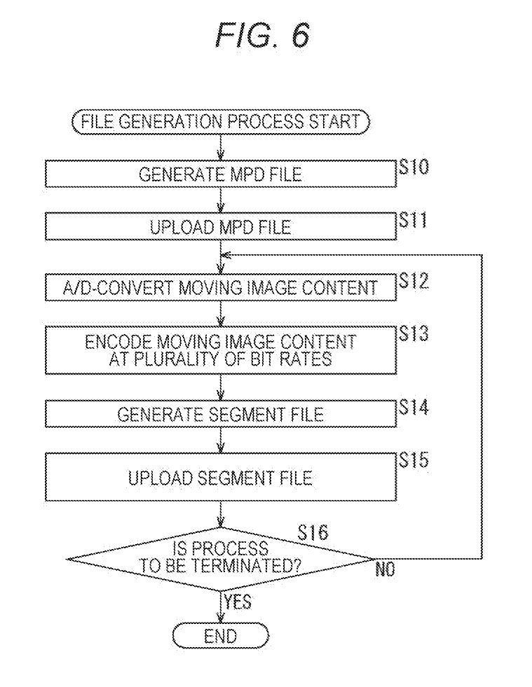

FIG. 6 is a flowchart for explaining a file generation process of the file generation device 11 in FIG. 3.

In step S10 of FIG. 6, the MPD file generation unit 34 of the file generation device 11 generates an MPD file to supply to the upload unit 35. In step S11, the upload unit 35 uploads the MPD file supplied from the MPD file generation unit 34 to the Web server 12.

In step S12, the acquisition unit 31 acquires a video analog signal and an audio analog signal of moving image content in units of segments to A/D-convert. The acquisition unit 31 supplies the encoding unit 32 with signals such as a video digital signal and an audio analog signal obtained as a result of the A/D conversion and other signals of the moving image content in units of segments.

In step S13, the encoding unit 32 encodes the signals of the moving image content supplied from the acquisition unit 31 at a plurality of bit rates by a predetermined encoding technique to generate an encoded stream. The encoding unit 32 supplies the generated encoded stream to the segment file generation unit 33.

In step S14, the segment file generation unit 33 transforms the encoded stream supplied from the encoding unit 32 into a file for each bit rate to generate a segment file. The segment file generation unit 33 supplies the generated segment file to the upload unit 35.

In step S15, the upload unit 35 uploads the segment file supplied from the segment file generation unit 33 to the Web server 12.

In step S16, the acquisition unit 31 determines whether to terminate the file generation process. Specifically, the acquisition unit 31 determines not to terminate the file generation process in a case where a signal of the moving image content in units of segments is newly supplied. Then, the process returns to step S12 and the processes in steps S12 to S16 are repeated until it is determined to terminate the file generation process.

On the other hand, in a case where a signal of the moving image content in units of segment is not newly supplied, the acquisition unit 31 determines to terminate the file generation process in step S16. Then, the process is terminated.

As described above, in a case where the encoding technique for the audio stream is the lossless DSD technique, the file generation device 11 describes <SupplementalProperty schemeIdUri=“urn:mpeg:DASH:audio:cbr:2015” value=“false”> in the MPD file. Therefore, the moving image reproduction terminal 14 can recognize that the encoding technique for the audio stream is not the fixed technique.

(Functional Configuration Example of Moving Image Reproduction Terminal)

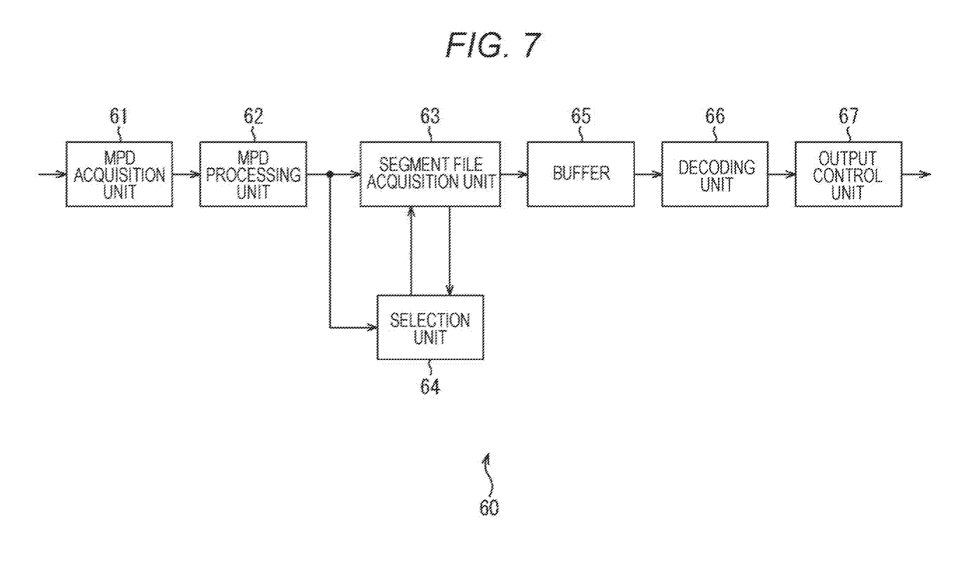

FIG. 7 is a block diagram illustrating a configuration example of a streaming reproduction unit implemented by the moving image reproduction terminal 14 in FIG. 1 executing the control software 21, the moving image reproduction software 22, and the access software 23.

The streaming reproduction unit 60 is constituted by an MPD acquisition unit 61, an MPD processing unit 62, a segment file acquisition unit 63, a selection unit 64, a buffer 65, a decoding unit 66, and an output control unit 67.

The MPD acquisition unit 61 of the streaming reproduction unit 60 requests the MPD file from the Web server 12 to acquire. The MPD acquisition unit 61 supplies the acquired MPD file to the MPD processing unit 62.

The MPD processing unit 62 analyzes the MPD file supplied from the MPD acquisition unit 61. Specifically, the MPD processing unit 62 acquires acquisition information such as Bandwidth of each encoded stream and the URL and file name of a segment file saving therein each encoded stream.

In addition, in a case where the encoded stream is an audio stream, the MPD processing unit 62 recognizes, on the basis of the value of <SupplementalProperty schemeIdUri=“urn:mpeg:DASH:audio:cbr:2015”>, whether the encoding technique for the audio stream corresponding to this value is the fixed technique. Then, the MPD processing unit 62 generates encoding technique information indicating whether the encoding technique for each audio stream is the fixed technique. The MPD processing unit 62 supplies Bandwidth, the acquisition information, the encoding technique information, and the like obtained as a result of the analysis to the segment file acquisition unit 63 and supplies Bandwidth to the selection unit 64.

In a case where at least one piece of the encoding technique information of respective audio streams indicates that the encoding technique is not the fixed technique, the segment file acquisition unit 63 selects an audio stream to be acquired from audio streams having different Bandwidths, on the basis of the network band of the Internet 13 and Bandwidth of each audio stream. Then, the segment file acquisition unit 63 (acquisition unit) transmits the acquisition information of a segment file at the reproduction time among the segment files of the selected audio stream to the Web server 12 and acquires this segment file.

In addition, the segment file acquisition unit 63 detects the actual bit rate of the acquired audio stream to supply to the selection unit 64. Furthermore, the segment file acquisition unit 63 transmits the acquisition information of a segment file at the reproduction time among the segment files of the video stream with Bandwidth supplied from the selection unit 64 to the Web server 12 and acquires this segment file.

On the other hand, in a case where all of the encoding technique information of respective audio streams indicate that the encoding technique is the fixed technique, the segment file acquisition unit 63 selects Bandwidths of a video stream and an audio stream to be acquired, on the basis of Bandwidth of each encoded stream and the network band of the Internet 13. Then, the segment file acquisition unit 63 transmits the acquisition information of a segment file at the reproduction time among the segment files of the video stream and the audio stream with the selected Bandwidths to the Web server 12 and acquires this segment file. The segment file acquisition unit 63 supplies an encoded stream saved in the acquired segment file to the buffer 65.

On the basis of the actual bit rate of the audio stream, the network band of the Internet 13, and Bandwidth of the video stream, the selection unit 64 selects a video stream to be acquired from video streams having different Bandwidths. The selection unit 64 supplies Bandwidth of the selected video stream to the segment file acquisition unit 63.

The buffer 65 temporarily holds the encoded stream supplied from the segment file acquisition unit 63.

The decoding unit 66 reads the encoded stream from the buffer 65 to decode and generates a video digital signal and an audio digital signal of the moving image content. The decoding unit 66 supplies the generated video digital signal and audio digital signal to the output control unit 67.

On the basis of the video digital signal supplied from the decoding unit 66, the output control unit 67 displays an image on a display unit such as a display (not illustrated) included in the moving image reproduction terminal 14. In addition, the output control unit 67 performs digital-analog (D/A) conversion on the audio digital signal supplied from the decoding unit 66. On the basis of an audio analog signal obtained as a result of the D/A conversion, the output control unit 67 causes an output unit such as a speaker (not illustrated) included in the moving image reproduction terminal 14 to output sound.

(Example of Actual Bit Rate of Audio Stream)

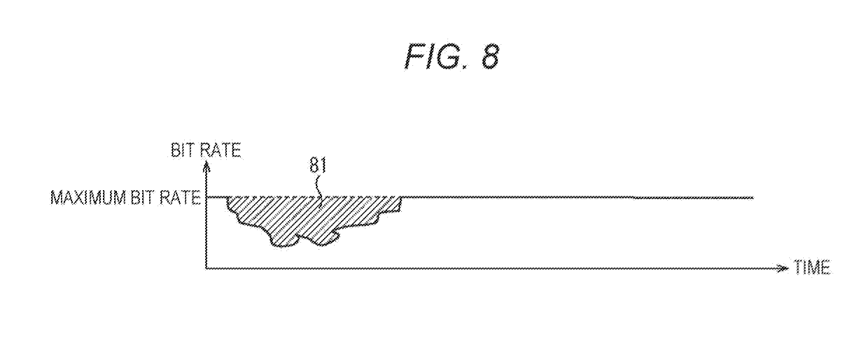

FIG. 8 is a diagram illustrating an example of the actual bit rate of the audio stream in a case where the encoding technique is the lossless DSD technique.

As illustrated in FIG. 8, in a case where the encoding technique is the lossless DSD technique, the actual bit rate of the audio stream fluctuates below the maximum bit rate indicated by Bandwidth.

However, the actual bit rate of the audio stream is unpredictable. Therefore, in a case where the moving image content is live-distributed, the moving image reproduction terminal 14 cannot recognize the actual bit rate of the audio stream until acquiring the audio stream.

Accordingly, the moving image reproduction terminal 14 acquires the actual bit rate of the audio stream by acquiring the audio stream before selecting the bit rate of the video stream. With this operation, the moving image reproduction terminal 14 can allocate a band other than the actual bit rate of the audio stream to the video stream from the network band of the Internet 13. That is, a surplus band 81, which is a difference between the maximum bit rate and the actual bit rate of the audio stream, can be allocated to the video stream.

In contrast to this, in the case of allocating the network band of the Internet 13 on the basis of Bandwidth indicating the maximum bit rate of the audio stream, it is not possible to allocate the surplus band 81 to the video stream and wasteful use of the band occurs.

(Explanation of Process of Moving Image Reproduction Terminal)

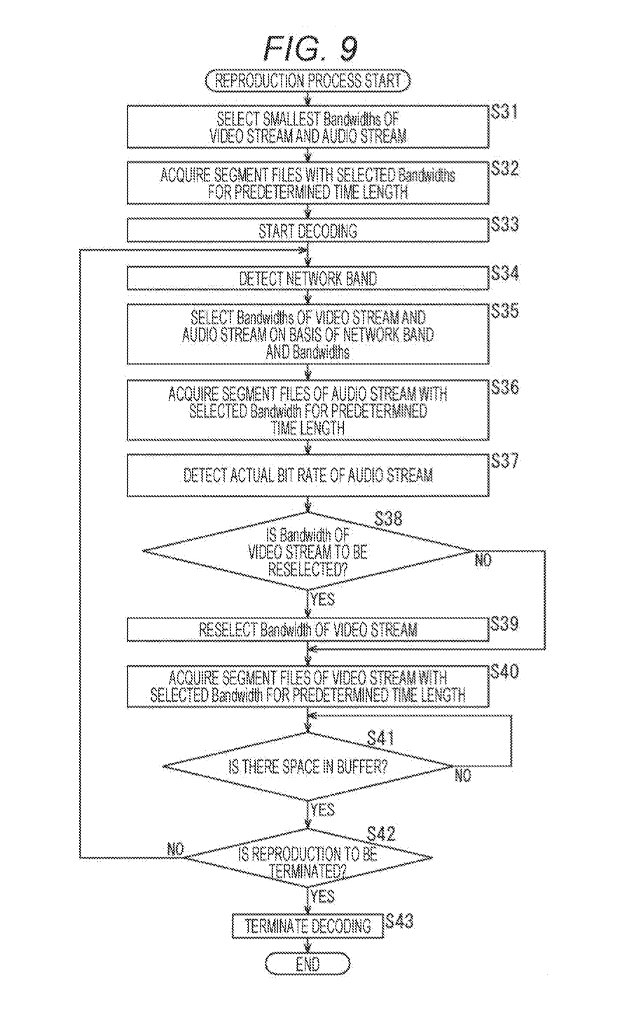

FIG. 9 is a flowchart for explaining a reproduction process of the streaming reproduction unit 60 in FIG. 7. This reproduction process is started in a case where the MPD file is acquired and the MPD file indicates that at least one piece of the encoding technique information of respective audio streams generated as a result of the analysis of the MPD file is not the fixed technique.

In step S31 of FIG. 9, the segment file acquisition unit 63 selects smallest Bandwidths of the video stream and the audio stream from among Bandwidths of respective encoded streams supplied from the MPD processing unit 62.

In step S32, the segment file acquisition unit 63 transmits the acquisition information of segment files for a predetermined time length from the reproduction start time, among segment files of the video stream and the audio stream with Bandwidths selected in step S31, to the Web server 12 in units of segments and acquires these segment files in units of segments.

This predetermined time length is a time length of the encoded stream which is desired to be held in the buffer 65 before a decoding start to detect the network band of the Internet 13. For example, this predetermined time length is 25% of a time length of the encoded stream that can be held in the buffer 65 (for example, about 30 seconds to 60 seconds) (hereinafter referred to as the maximum time length). The segment file acquisition unit 63 supplies the encoded stream saved in each acquired segment file to the buffer 65 to hold.

In step S33, the decoding unit 66 starts decoding the encoded stream stored in the buffer 65. Note that the encoded stream read and decoded by the decoding unit 66 is deleted from the buffer 65. The decoding unit 66 supplies the video digital signal and the audio digital signal of the moving image content obtained as a result of decoding to the output control unit 67. On the basis of the video digital signal supplied from the decoding unit 66, the output control unit 67 displays an image on a display unit such as a display (not illustrated) included in the moving image reproduction terminal 14. In addition, the output control unit 67 D/A-converts the audio digital signal supplied from the decoding unit 66 and, on the basis of an audio analog signal obtained as a result of the D/A conversion, causes an output unit such as a speaker (not illustrated) included in the moving image reproduction terminal 14 to output sound.

In step S34, the segment file acquisition unit 63 detects the network band of the Internet 13.

In step S35, the segment file acquisition unit 63 selects Bandwidths of the video stream and the audio stream on the basis of the network band of the Internet 13 and Bandwidth of each encoded stream. Specifically, the segment file acquisition unit 63 selects Bandwidths of the video stream and the audio stream such that the sum of the selected Bandwidths of the video stream and audio stream are not more than the network band of the Internet 13.

In step S36, the segment file acquisition unit 63 transmits the acquisition information of segment files for a predetermined time length from the time subsequent to the time of the segment files acquired in step S32, among segment files of the audio stream with Bandwidth selected in step S35, to the Web server 12 in units of segments and acquires the segment files in units of segments.

This predetermined time length may be any time length as long as this predetermined time length is shorter than a time length insufficient for the time length of the encoded stream held in the buffer 65 with respect to the maximum time length. The segment file acquisition unit 63 supplies the audio stream saved in each acquired segment file to the buffer 65 to hold.

In step S37, the segment file acquisition unit 63 detects the actual bit rate of the audio stream acquired in step S36 to supply to the selection unit 64.

In step S38, the selection unit 64 determines whether to reselect Bandwidth of the video stream on the basis of the actual bit rate of the audio stream, Bandwidth of the video stream, and the network band of the Internet 13.

Specifically, the selection unit 64 determines whether Bandwidth of the video stream having the largest value equal to or less than a value obtained by subtracting the actual bit rate of the audio stream from the network band of the Internet 13 matches Bandwidth of the video stream selected in step S35.

Then, in a case where the selection unit 64 determines that above Bandwidth does not match Bandwidth of the video stream selected in step S35, the selection unit 64 determines to reselect Bandwidth of the video stream. On the other hand, in a case where it is determined that above Bandwidth matches Bandwidth of the video stream selected in step S35, the selection unit 64 determines not to reselect Bandwidth of the video stream.

In a case where it is determined in step S38 that Bandwidth of the video stream is to be reselected, the process proceeds to step S39.

In step S39, the selection unit 64 reselects Bandwidth of the video stream having the largest value equal to or less than a value obtained by subtracting the actual bit rate of the audio stream from the network band of the Internet 13. Then, the selection unit 64 supplies reselected Bandwidth to the segment file acquisition unit 63 and advances the process to step S40.

On the other hand, in a case where it is determined in step S38 that Bandwidth of the video stream is not to be reselected, the selection unit 64 supplies Bandwidth of the video stream selected in step S35 to the segment file acquisition unit 63 and advances the process to step S40.

In step S40, the segment file acquisition unit 63 transmits the acquisition information of segment files for a predetermined time length corresponding to the audio stream acquired in step S36, among segment files of the video stream with Bandwidth supplied from the selection unit 64, to the Web server 12 in units of segments and acquires these segment files in units of segments. The segment file acquisition unit 63 supplies the video stream saved in each acquired segment file to the buffer 65 to hold.

In step S41, the segment file acquisition unit 63 determines whether there is space in the buffer 65. In a case where it is determined in step S41 that there is no space in the buffer 65, the segment file acquisition unit 63 stands by until space is formed in the buffer 65.

On the other hand, in a case where it is determined in step S41 that there is space in the buffer 65, the streaming reproduction unit 60 determines in step S42 whether to terminate the reproduction. In a case where it is determined in step S42 that the reproduction is not to be terminated, the process returns to step S34 and the processes in steps S34 to S42 are repeated until the reproduction is terminated.

On the other hand, in a case where it is determined in step S42 that the reproduction is to be terminated, the decoding unit 66 completes the decoding of all the encoded streams stored in the buffer 65 and then terminates the decoding in step S43. Then, the process is terminated.

As described thus far, the moving image reproduction terminal 14 acquires the audio stream encoded by the lossless DSD technique before the video stream to acquire the actual bit rate of the audio stream and selects Bandwidth of the video stream to be acquired, on the basis of this actual bit rate.

Therefore, when the audio stream encoded by the lossless DSD technique and the video stream are acquired, it is possible to allocate a surplus band, which is a difference between Bandwidth and the actual bit rate of the audio stream, to the video stream. As a result, a video stream having an optimum bit rate can be acquired, as compared with the case of selecting Bandwidth of the video stream to be acquired on the basis of Bandwidth of the audio stream.

### Second Embodiment

(First Description Example of MPD File)

A second embodiment of the information processing system to which the present disclosure is applied differs from the configuration of the information processing system 10 in FIG. 1 in the configuration of the MPD file, that the MPD file is updated at every predetermined duration, the file generation process, and the reproduction process. Therefore, only the configuration of the MPD file, the file generation process, an update process for the MPD file, and the reproduction process will be described below.

In the second embodiment, after generating the audio stream, the file generation device 11 calculates the average value of the actual bit rates of the generated audio stream to describe in the MPD file. In the live distribution, since the average value changes as the audio stream is being generated, the moving image reproduction terminal 14 needs to periodically acquire and update the MPD file.

FIG. 10 is a diagram illustrating a first description example of the MPD file in the second embodiment.

The configuration of the MPD file in FIG. 10 differs from the configuration of the MPD file in FIG. 4 in that the representation element further has AveBandwidth and DurationForAveBandwidth.

AveBandwidth is information indicating the average value of the actual bit rates of the audio stream corresponding to the representation element over a predetermined duration. DurationForAveBandwidth is information indicating the predetermined duration corresponding to AveBandwidth.

Specifically, an MPD file generation unit 34 according to the second embodiment calculates the average value for each reference duration from the integrated value of the actual bit rates of the audio stream generated by an encoding unit 32, thereby calculating the average value of the actual bit rates of the audio stream over a predetermined duration increased by the reference duration.

Then, the MPD file generation unit 34 (generation unit) generates the calculated average value and the predetermined duration corresponding to this average value for each reference duration, as bit rate information representing the actual bit rate of the audio stream. Additionally, the MPD file generation unit 34 generates an MPD file including information indicating the average value from the bit rate information as AveBandwidth and information indicating the predetermined duration from the bit rate information as DurationForAveBandwidth.

In the example in FIG. 10, the MPD file generation unit 34 calculates the average value of the actual bit rates of the audio stream for 600 seconds from the top. Therefore, DurationForAveBandwidths included in three representation elements have PT600S indicating 600 seconds.

In addition, the average value of the actual bit rates for 600 seconds from the top of the audio stream by the lossless DSD technique having the maximum bit rate of 2.8 Mbps corresponding to the first representation element is 2 Mbps. Therefore, AveBandwidth included in the first representation element has 2000000.

The average value of the actual bit rates for 600 seconds from the top of the audio stream by the lossless DSD technique having the maximum bit rate of 5.6 Mbps corresponding to the second representation element is 4 Mbps. Therefore, AveBandwidth included in the second representation element has 4000000.

The average value of the actual bit rates for 600 seconds from the top of the audio stream by the lossless DSD technique having the maximum bit rate of 11.2 Mbps corresponding to the third representation element is 8 Mbps. Therefore, AveBandwidth included in the third representation element has 8000000.

(Second Description Example of MPD File)

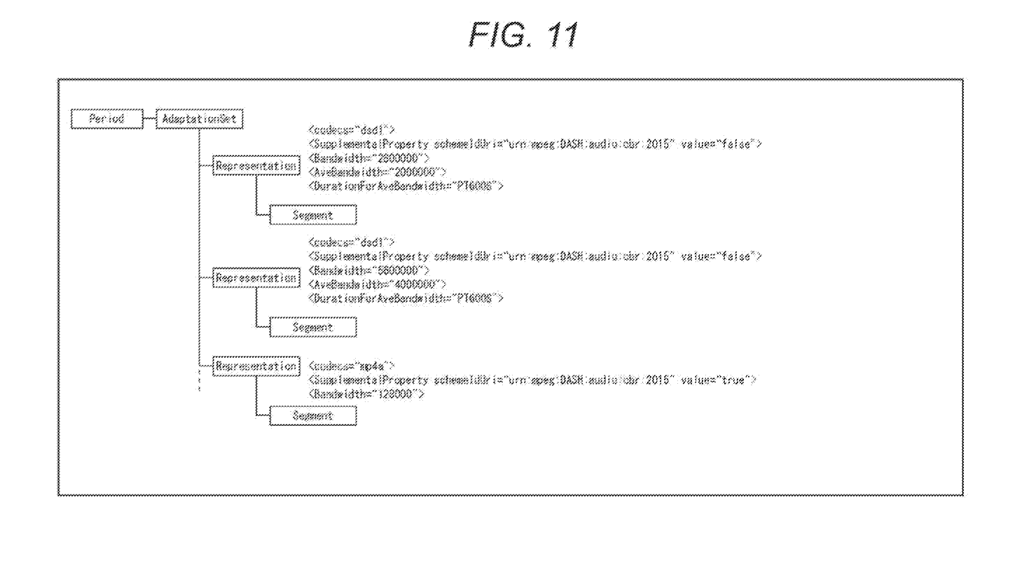

FIG. 11 is a diagram illustrating a second description example of the MPD file in the second embodiment.

The configuration of the MPD file in FIG. 11 differs from the configuration of the MPD file in FIG. 5 in that two representation elements corresponding to the audio streams encoded by the lossless DSD technique further have AveBandwidth and DurationForAveBandwidth.

AveBandwidths and DurationForAveBandwidths included in the two representation elements are the same as the AveBandwidths and DurationForAveBandwidths included in the first and second representation elements in FIG. 10, respectively, and thus the explanation thereof will be omitted.

Note that, in a case where the average value is calculated from the integrated value obtained by integrating the bit rates up to the bit rate of the last audio stream of the moving image content, the MPD file generation unit 34 may describe the time of the moving image content as DurationForAveBandwidth, or may omit the description of DurationForAveBandwidth.

In addition, although illustration is omitted, minimumUpdatePeriod indicating the reference duration as the update interval for the MPD file is included in the MPD files in FIGS. 10 and 11. Then, the moving image reproduction terminal 14 updates the MPD file at the update interval indicated by minimumUpdatePeriod. Therefore, the MPD file generation unit 34 can easily modify the update interval for the MPD file by only modifying minimumUpdatePeriod described in the MPD file.

Furthermore, AveBandwidth and DurationForAveBandwidth in FIGS. 10 and 11 may be described as SupplementalProperty descriptor rather than described as parameters of the representation element.

In addition, instead of AveBandwidth in FIGS. 10 and 11, the integrated value of the actual bit rates of the audio stream over the predetermined duration may be described.

Note that the MPD files in FIGS. 10 and 11 are configured such that AveBandwidth and DurationForAveBandwidth in addition to <codecs=“dsd1”> and <SupplementalProperty schemeIdUri=“urn:mpeg:DASH:audio:cbr:2015”> can be described in an MPD file for which a technique other than the fixed technique is not assumed as the encoding technique for the audio stream. Therefore, the MPD files in FIGS. 10 and 11 are compatible with an MPD file for which a technique other than the fixed technique is not assumed as the encoding technique for the audio stream.

(Explanation of Process of Information Processing System)

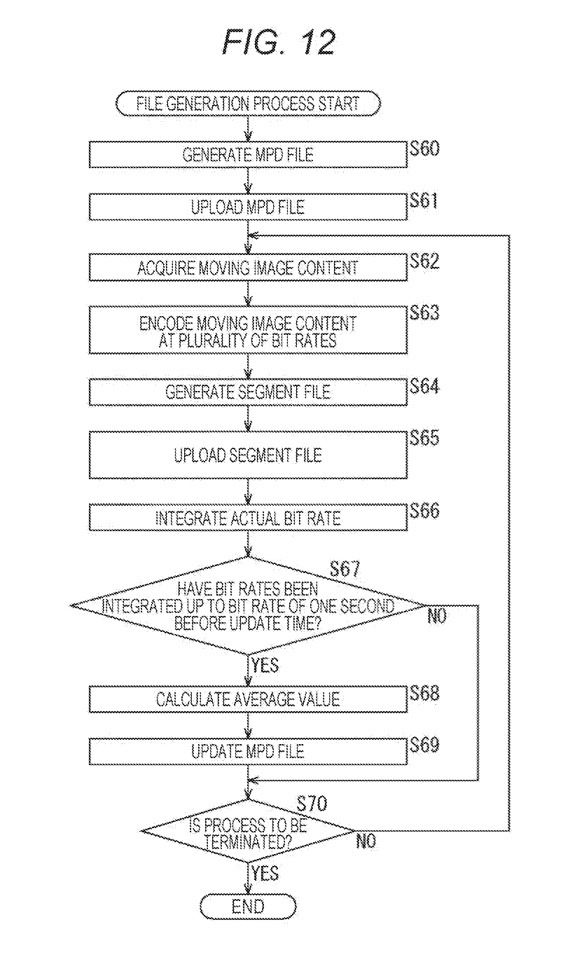

FIG. 12 is a flowchart for explaining a file generation process of a file generation device 11 in the second embodiment. This file generation process is performed in a case where at least one of the encoding techniques for the audio streams is the lossless DSD technique.

In step S60 of FIG. 12, the MPD file generation unit 34 of the file generation device 11 generates an MPD file. At this time, since the average value of the actual bit rates of the audio stream has not yet been calculated, for example, the same value as that of Bandwidth is described in AveBandwidth and PTOS indicating zero seconds is described in DurationForAveBandwidth in the MPD file. In addition, for example, a reference duration ΔT is set in minimumUpdatePeriod in the MPD file. The MPD file generation unit 34 supplies the generated MPD file to an upload unit 35.

Since the processes in steps S61 to S65 are similar to the processes in steps S11 to S15 of FIG. 6, the explanation will be omitted.

In step S66, the MPD file generation unit 34 integrates the actual bit rate of the audio stream to the integrated value being held and holds an integrated value obtained as a result of the integration.

In step S67, the MPD file generation unit 34 determines whether the actual bit rates have been integrated up to the actual bit rate of an audio stream with reproduction time one second before the update time of the MPD file by the process in step S66. Note that, in the example in FIG. 12, since the time until the MPD file having the updated integrated value is actually uploaded to the Web server 12 is one second, the MPD file generation unit 34 determines whether the actual bit rates have been integrated up to the actual bit rate of an audio stream with reproduction time one second before the update time. However, the above time is, of course, not limited to one second and, in the case of a value other than one second, it is determined whether the actual bit rates have been integrated up to the actual bit rate of an audio stream with reproduction time earlier than the update time by that time. In addition, the update time of the MPD file during the process in step S67 at the first time is after the reference duration ΔT from zero seconds, while the update time of the MPD file during the process in step S67 at the next time is after twice the reference duration ΔT from zero seconds. Thereafter, the update time of the MPD file is similarly increased by the reference duration ΔT every time.

In a case where it is determined in step S67 that the actual bit rates have been integrated up to the actual bit rate of an audio stream with reproduction time one second before the update time of the MPD file by the process in step S66, the process proceeds to step S68. In step S68, the MPD file generation unit 34 calculates the average value by dividing the integrated value being held by a duration of the audio stream corresponding to the integrated bit rates.

In step S69, the MPD file generation unit 34 updates AveBandwidth and DurationForAveBandwidth in the MPD file to information indicating the average value calculated in step S67 and information indicating the duration corresponding to this average value, respectively, and advances the process to S70.

On the other hand, in a case where it is determined in step S67 that the actual bit rates have not been integrated yet up to the actual bit rate of an audio stream with reproduction time one second before the update time of the MPD file by the process in step S66, the process proceeds to step S70.

Since the process in step S70 is the same as the process in step S16 of FIG. 6, the explanation will be omitted.

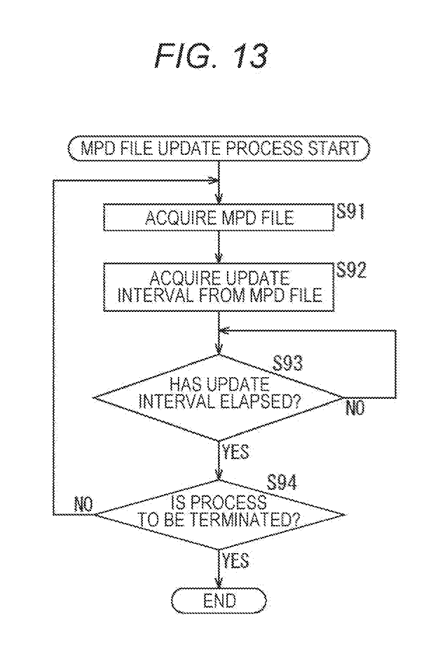

FIG. 13 is a flowchart for explaining an MPD file update process of a streaming reproduction unit 60 in the second embodiment. This MPD file update process is performed in a case where minimumUpdatePeriod is described in the MPD file.

In step S91 of FIG. 13, an MPD acquisition unit 61 of the streaming reproduction unit 60 acquires the MPD file to supply to an MPD processing unit 62. In step S92, the MPD processing unit 62 acquires the update interval indicated by minimumUpdatePeriod from the MPD file by analyzing the MPD file supplied from the MPD acquisition unit 61.

In addition, similarly to the case of the first embodiment, the MPD processing unit 62 analyzes the MPD file to obtain Bandwidth, the acquisition information, the encoding technique information, and the like of the encoded stream. Furthermore, in a case where the encoding technique information indicates that the encoding technique is not the fixed technique as a consequence of the analysis of the MPD file, the MPD processing unit 62 acquires AveBandwidth of the audio stream to assign as a selection bit rate. Meanwhile, in a case where the encoding technique information indicates that the encoding technique is the fixed technique, the MPD processing unit 62 assigns Bandwidth of the audio stream as the selection bit rate.

The MPD processing unit 62 supplies a segment file acquisition unit 63 with Bandwidth and the acquisition information of each video stream, and the selection bit rate, the acquisition information, and the encoding technique information of each audio stream. The MPD processing unit 62 also supplies the selection bit rate of each audio stream to a selection unit 64.

In step S93, the MPD acquisition unit 61 determines whether the update interval has elapsed from the acquisition of the MPD file by the process in step S91 at the previous time. In a case where it is determined in step S93 that the update interval has not elapsed, the MPD acquisition unit 61 stands by until the update interval has elapsed.

In a case where it is determined in step S93 that the update interval has elapsed, the process proceeds to step S94. In step S94, the streaming reproduction unit 60 determines whether to terminate the reproduction process. In a case where it is determined in step S94 that the reproduction process is not to be terminated, the process returns to step S91 and the processes in steps S91 to S94 are repeated until the reproduction process is terminated.

On the other hand, in a case where it is determined in step S94 that the reproduction process is to be terminated, the process is terminated.

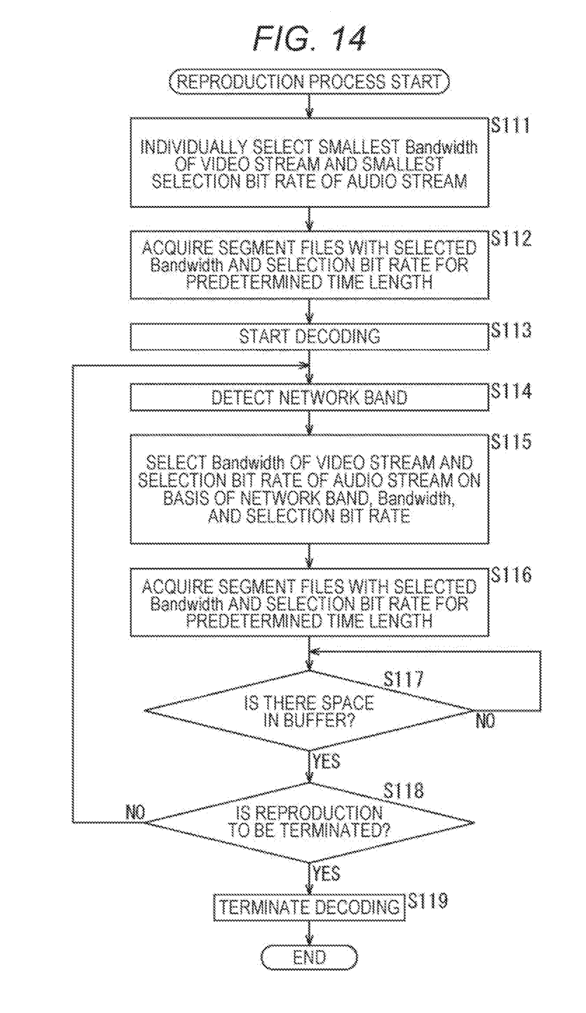

FIG. 14 is a flowchart for explaining a reproduction process of the streaming reproduction unit 60 in the second embodiment. This reproduction process is performed in parallel with the MPD file update process in FIG. 13.

In step S111 of FIG. 14, the segment file acquisition unit 63 individually selects smallest Bandwidth of the video stream and a smallest selection bit rate of the audio stream supplied from the MPD processing unit 62.

In step S112, the segment file acquisition unit 63 transmits the acquisition information of segment files for a predetermined time length from the reproduction start time, among segment files of the video stream with Bandwidth selected in step S111 and the audio stream with the selection bit rate selected in step S111, to the Web server 12 in units of segments and acquires these segment files in units of segments. This predetermined time length is the same as the time length in step S32 of FIG. 9. The segment file acquisition unit 63 supplies the acquired segment files to the buffer 65 to hold.

Since the processes in steps S113 and S114 are similar to the processes in steps S33 and S34 of FIG. 9, the explanation will be omitted.

In step S115, a segment file acquisition unit 63 selects Bandwidth of the video stream and the selection bit rate of the audio stream on the basis of the network band of the Internet 13, Bandwidth of the video stream, and the selection bit rate of the audio stream.

Specifically, the segment file acquisition unit 63 selects Bandwidth of the video stream and the selection bit rate of the audio stream such that the sum of Bandwidth of the video stream and the selection bit rate of the audio stream that have been selected are not more than the network band of the Internet 13.

In step S116, the segment file acquisition unit 63 transmits the acquisition information of segment files for a predetermined time length from the time subsequent to the time of the segment files acquired in step S112, among segment files of the video stream with Bandwidth selected in step S115 and the audio stream with the selection bit rate selected in step S115, to the Web server 12 in units of segments and acquires these segment files in units of segments. The segment file acquisition unit 63 supplies the acquired segment files to the buffer 65 to hold.

Note that, since AveBandwidth is the average value of the actual bit rates of the audio stream, the actual bit rate exceeds AveBandwidth in some cases. Therefore, the predetermined time length in step S116 is assigned as a time length shorter than the reference duration ΔT. With this configuration, the network band of the Internet 13 becomes smaller and an audio stream with a lower selection bit rate is acquired in a case where the actual bit rate exceeds AveBandwidth. As a result, overflow of the buffer 65 can be prevented.

Since the processes in steps S117 to S119 are similar to the processes in steps S41 to S43 of FIG. 9, the explanation will be omitted.

As described thus far, the file generation device 11 according to the second embodiment generates the average value of the actual bit rates of the audio stream encoded by the lossless DSD technique. Therefore, by selecting Bandwidth of the video stream to be acquired on the basis of the average value of the actual bit rates of the audio stream, the moving image reproduction terminal 14 can allocate at least a part of the surplus band, which is a difference between Bandwidth and the actual bit rate of the audio stream, to the video stream. As a result, a video stream having an optimum bit rate can be acquired, as compared with the case of selecting Bandwidth of the video stream to be acquired on the basis of Bandwidth of the audio stream.

In addition, in the second embodiment, there is no need to acquire the audio stream before acquiring the video stream in order to acquire the actual bit rate of the audio stream. Furthermore, in the second embodiment, since the file generation device 11 updates AveBandwidth in the MPD file at every reference duration, the moving image reproduction terminal 14 can acquire latest AveBandwidth by acquiring the latest MPD file at the reproduction start time.

### Third Embodiment

(Configuration Example of Media Segment File of Audio Stream)

A third embodiment of the information processing system to which the present disclosure is applied differs from the second embodiment mainly in that minimumUpdatePeriod is not described in the MPD file but update notification information that notifies the update time of the MPD file is saved in the media segment file of the audio stream. Therefore, only the segment file of the audio stream, the file generation process, the MPD file update process, and the reproduction process will be described below.

FIG. 15 is a diagram illustrating a configuration example of a media segment file including update notification information of the audio stream according to the third embodiment.

The media segment file (Media Segment) in FIG. 15 is constituted by a styp box, a sidx box, an emsg box (Event Message Box), and one or more Movie fragments.

The styp box is a box that saves therein information indicating the format of the media segment file. In the example in FIG. 15, msdh indicating that the format of the media segment file is an MPEG-DASH format is saved in the styp box. The sidx box is a box that saves therein index information of a subsegment made up of one or more Movie fragments.

The emsg box is a box that saves therein the update notification information using MPD validity expiration. Movie fragment is constituted by a moof box and an mdat box. The moof box is a box that saves therein metadata of the audio stream, while the mdat box is a box that saves therein the audio stream. Movie fragment constituting Media Segment is divided into one or more subsegments.

(Description Example of emsg Box)

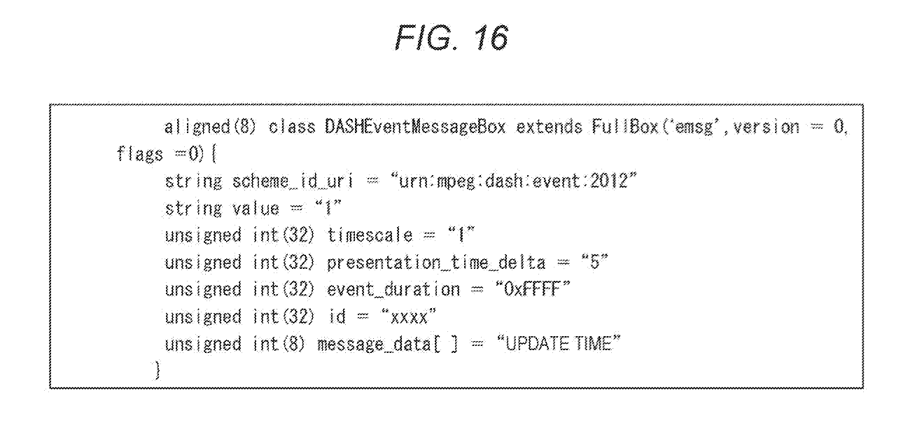

FIG. 16 is a diagram illustrating a description example of the emsg box in FIG. 15.

As illustrated in FIG. 16, string value, presentation_time_delta, event_duration, id, message_data, and the like are described in the emsg box.

string value is a value that defines an event corresponding to this emsg box and, in the case of FIG. 16, string value has 1 indicating the update of the MPD file.

presentation_time_delta specifies the time from the reproduction time of the media segment file in which this emsg box is placed to the reproduction time when the event is performed. Therefore, in the case of FIG. 16, presentation_time_delta specifies the time from the reproduction time of the media segment file in which this emsg box is placed to the reproduction time when the MPD file is updated and serves as the update notification information. In the third embodiment, presentation_time_delta has 5. Accordingly, the MPD file is updated five seconds after the reproduction time of the media segment file in which this emsg box is placed.

event_duration specifies the duration of the event corresponding to this emsg box and, in the case of FIG. 16, event_duration has “0xFFFF” indicating that the duration is unknown. id specifies an identification (ID) unique to this emsg box. In addition, message_data specifies data relating to the event corresponding to this emsg box and, in the case of FIG. 16, message_data has extensible markup language (XML) data of the update time of the MPD file.

As described above, a file generation device 11 includes the emsg box in FIG. 16, which saves therein presentation_time_delta, into the media segment file of the audio stream as necessary. With this operation, the file generation device 11 can notify the moving image reproduction terminal 14 of how many seconds from the reproduction time of this media segment file are to elapse before the MPD file is updated.

In addition, the file generation device 11 can easily modify the update frequency of the MPD file merely by modifying the frequency of placing the emsg box in the media segment file.

(Explanation of Process of File Generation Device)

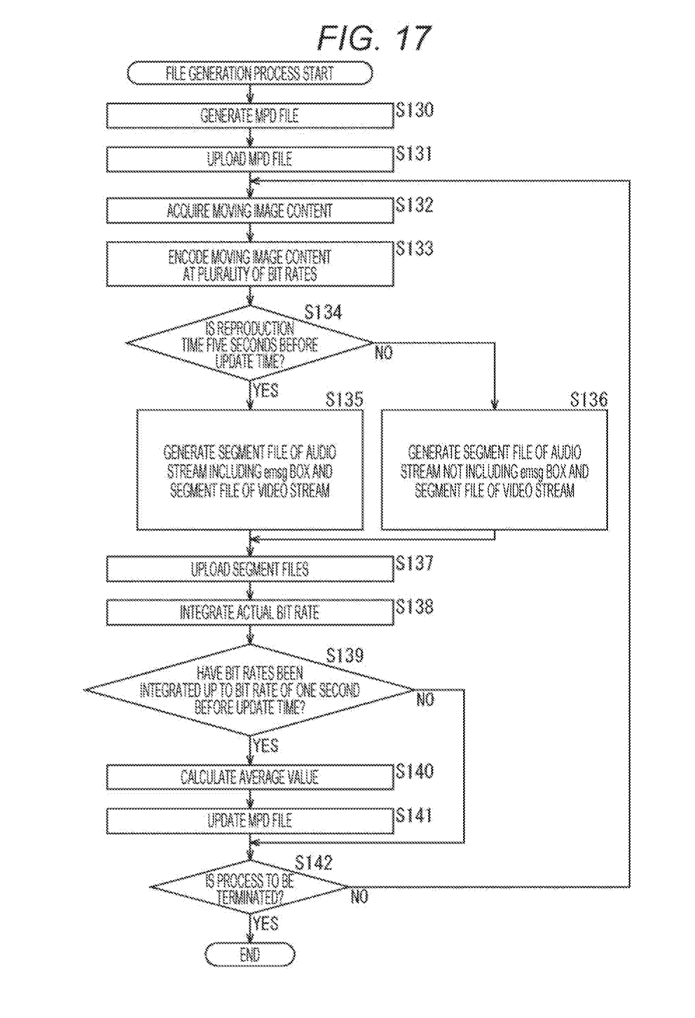

FIG. 17 is a flowchart for explaining a file generation process of the file generation device 11 according to the third embodiment. This file generation process is performed in a case where at least one of the encoding techniques for the audio streams is the lossless DSD technique.

In step S130 of FIG. 17, an MPD file generation unit 34 of the file generation device 11 generates an MPD file. This MPD file differs from the MPD file in the second embodiment in that minimumUpdatePeriod is not described and “urn:mpeg:dash:profile:is-off-ext-live:2014” is described. “urn:mpeg:dash:profile:is-off-ext-live:2014” is a profile indicating that the emsg box in FIG. 16 is placed in the media segment file. The MPD file generation unit 34 supplies the generated MPD file to an upload unit 35.

Since the processes in steps S131 to S133 are similar to the processes in steps S61 to S63 of FIG. 12, the explanation will be omitted.

In step S134, a segment file generation unit 33 of the file generation device 11 determines whether the reproduction time of the audio digital signal encoded in step S133 is five seconds before the update time of the MPD file. Note that, in the example in FIG. 17, since the MPD file update is notified to the moving image reproduction terminal 14 five seconds before, the segment file generation unit 33 determines whether the reproduction time is five seconds before the update time of the MPD file. However, the notification to the moving image reproduction terminal 14 may be, of course, made earlier by a time other than five seconds and, in a case where the notification is made earlier by a time other than five seconds, it is determined whether the reproduction time is earlier than the update time of the MPD file by that time. In addition, the update time of the MPD file during the process in step S134 at the first time is after the reference duration ΔT from zero seconds, while the update time of the MPD file during the process in step S134 at the next time is after twice the reference duration ΔT from zero seconds. Thereafter, the update time of the MPD file is similarly increased by the reference duration ΔT every time.

In a case where it is determined in step S134 that the reproduction time is five seconds before the update time of the MPD file, the process proceeds to step S135. In step S135, the segment file generation unit 33 generates a segment file of the audio stream supplied from an encoding unit 32, which includes the emsg box in FIG. 16. The segment file generation unit 33 also generates a segment file of the video stream supplied from the encoding unit 32. Then, the segment file generation unit 33 supplies the generated segment files to the upload unit 35 and advances the process to step S137.

On the other hand, in a case where it is determined in step S134 that the reproduction time is not five seconds before the update time of the MPD file, the process proceeds to step S136. In step S136, the segment file generation unit 33 generates a segment file of the audio stream supplied from the encoding unit 32, which does not include the emsg box in FIG. 16. The segment file generation unit 33 also generates a segment file of the video stream supplied from the encoding unit 32. Then, the segment file generation unit 33 supplies the generated segment files to the upload unit 35 and advances the process to step S137.

Since the processes in steps S137 to S142 are the same as the processes in steps S65 to S70 of FIG. 12, the explanation will be omitted.

Note that, although illustration is omitted, the MPD file update process of a streaming reproduction unit 60 in the third embodiment is a process in which an MPD acquisition unit 61 acquires the MPD file after five seconds when the emsg box in FIG. 16 is included in the media segment file acquired by a segment file acquisition unit 63. In the third embodiment, presentation_time_delta has 5 but of course is not limited to this value.

In addition, the reproduction process of the streaming reproduction unit 60 in the third embodiment is the same as the reproduction process in FIG. 14 and is performed in parallel with the MPD file update process.

As described thus far, in the third embodiment, the moving image reproduction terminal 14 only needs to acquire the MPD file solely in the case of acquiring the media segment file including the emsg box, such that an increase in HTTP overhead other than the acquisition of the encoded stream can be suppressed.

### Fourth Embodiment

(Description Example of emsg Box)

A fourth embodiment of the information processing system to which the present disclosure is applied differs from the third embodiment mainly in that the emsg box that saves therein updated values of AveBandwidth and DurationForAveBandwidth as update information of the MPD file (differential information between before and after update) is placed in the segment file of the audio stream, rather than updating the MPD file.

That is, in the fourth embodiment, initial values of AveBandwidth and DurationForAveBandwidth are included in the MPD file, while updated values of AveBandwidth and DurationForAveBandwidth are included in the segment file of the audio stream. Therefore, only the emsg box that saves therein updated values of AveBandwidth and DurationForAveBandwidth, the file generation process, the MPD file update process, and the reproduction process will be described below.

FIG. 18 is a diagram illustrating a description example of the emsg box in the fourth embodiment, which saves therein updated values of AveBandwidth and DurationForAveBandwidth.

In the emsg box in FIG. 18, string value has 2 indicating the transmission of the update information of the MPD file. In addition, presentation_time_delta is set with 0 as the time from the reproduction time of the media segment file in which this emsg box is placed to the reproduction time when the update information of the MPD file is transmitted. With this configuration, a moving image reproduction terminal 14 can recognize that the update information of the MPD file is placed in the media segment file in which this emsg box is placed.

As in the case of FIG. 16, event_duration has “0xFFFF”. In addition, message_data has XML data of the updated values of AveBandwidth and DurationForAveBandwidth, which is the update information of the MPD file.

(Explanation of Process of File Generation Device)

FIG. 19 is a flowchart for explaining a file generation process of a file generation device 11 in the fourth embodiment. This file generation process is performed in a case where at least one of the encoding techniques for the audio streams is the lossless DSD technique.

In step S160 of FIG. 19, an MPD file generation unit 34 of the file generation device 11 generates an MPD file. This MPD file is the same as the MPD file in the third embodiment except that the profile is replaced with a profile indicating that the emsg boxes in FIGS. 16 and 18 are placed in the media segment file. The MPD file generation unit 34 supplies the generated MPD file to an upload unit 35.

Since the processes in steps S161 to S164 are similar to the processes in steps S131 to S134 of FIG. 17, the explanation will be omitted.

In a case where it is determined in step S164 that the reproduction time is not five seconds before the update time of the MPD file, the process proceeds to step S165. Since the processes in steps S165 to S167 are similar to the processes in steps S138 to S140 of FIG. 17, the explanation will be omitted.

In step S168, a segment file generation unit 33 generates a segment file of the audio stream supplied from an encoding unit 32, which includes the emsg box in FIG. 18 including an average value calculated in step S167 as the updated value of AveBandwidth and including a duration corresponding to this average value as the updated value of DurationForAveBandwidth. The segment file generation unit 33 also generates a segment file of the video stream supplied from the encoding unit 32. Then, the segment file generation unit 33 supplies the generated segment files to the upload unit 35 and advances the process to step S172.

On the other hand, in a case where it is determined in step S166 that the actual bit rates have not been integrated yet up to the actual bit rate of an audio stream with reproduction time one second before the update time of the MPD file, the process proceeds to step S169.

In step S169, the segment file generation unit 33 generates a segment file of the audio stream supplied from the encoding unit 32, which does not include the emsg box in FIG. 16 or the emsg box in FIG. 18. The segment file generation unit 33 also generates a segment file of the video stream supplied from the encoding unit 32. Then, the segment file generation unit 33 supplies the generated segment files to the upload unit 35 and advances the process to step S172.

On the other hand, in a case where it is determined in step S164 that the reproduction time is five seconds before the update time, in step S170, the segment file generation unit 33 generates a segment file of the audio stream supplied from an encoding unit 32, which includes the emsg box in FIG. 16 saving therein the update notification information. The segment file generation unit 33 also generates a segment file of the video stream supplied from the encoding unit 32. Then, the segment file generation unit 33 supplies the generated segment files to the upload unit 35.

In step S171, the MPD file generation unit 34 integrates the actual bit rate of the audio stream to the integrated value being held and holds an integrated value obtained as a result of the integration to advance the process to step S172.

In step S172, the upload unit 35 uploads the segment files supplied from the segment file generation unit 33 to the Web server 12.

Since the process in step S173 is similar to the process in step S142 of FIG. 17, the explanation will be omitted.

Note that, although illustration is omitted, the MPD file update process of a streaming reproduction unit 60 in the fourth embodiment is a process in which, when the emsg box in FIG. 16 is included in the media segment file acquired by a segment file acquisition unit 63, the updated values of AveBandwidth and DurationForAveBandwidth are acquired from the emsg box in FIG. 18 of the media segment file after five seconds and the MPD file is updated.

In addition, the reproduction process of the streaming reproduction unit 60 in the fourth embodiment is the same as the reproduction process in FIG. 14 and is performed in parallel with the MPD file update process.

As described thus far, in the fourth embodiment, only the updated values of AveBandwidth and DurationForAveBandwidth are transferred to the moving image reproduction terminal 14. Therefore, it is possible to reduce a transfer amount necessary for updating AveBandwidth and DurationForAveBandwidth. In addition, an MPD processing unit 62 only needs to analyze solely the description relating to AveBandwidth and DurationForAveBandwidth for the updated MPD file, such that the analysis load is mitigated.

Furthermore, in the fourth embodiment, since the updated values of AveBandwidth and DurationForAveBandwidth are saved in the segment file of the audio stream, it is not necessary to acquire the MPD file every time the MPD file is updated. Therefore, an increase in HTTP overhead other than the acquisition of the encoded stream can be suppressed.

### Fifth Embodiment

(Description Example of emsg Box)

A fifth embodiment of the information processing system to which the present disclosure is applied differs from the fourth embodiment mainly in that initial values of AveBandwidth and DurationForAveBandwidth are not described in the MPD file and that the emsg box that saves therein the update notification information is not placed in the segment file of the audio stream. Therefore, only the emsg box that saves therein AveBandwidth and DurationForAveBandwidth, the file generation process, the update process for AveBandwidth and DurationForAveBandwidth, and the reproduction process will be described below.

FIG. 20 is a diagram illustrating a description example of the emsg box in the fifth embodiment, which saves therein AveBandwidth and DurationForAveBandwidth.

In the emsg box in FIG. 20, string value has 3 indicating the transmission of AveBandwidth and DurationForAveBandwidth. In addition, presentation_time_delta is set with 0 as the time from the reproduction time of the media segment file in which this emsg box is placed to the reproduction time when AveBandwidth and DurationForAveBandwidth are transmitted. With this configuration, a moving image reproduction terminal 14 can recognize that AveBandwidth and DurationForAveBandwidth are placed in the media segment file in which this emsg box is placed.

As in the case of FIG. 16, event_duration has “0xFFFF”. In addition, message_data has XML data of AveBandwidth and DurationForAveBandwidth.

A file generation device 11 can easily modify the update frequency of AveBandwidth and DurationForAveBandwidth merely by modifying the frequency of placing the emsg box in FIG. 20 in the media segment file of the audio stream.

Note that, although illustration is omitted, the file generation process of the file generation device 11 in the fifth embodiment is similar to the file generation process in FIG. 19, except mainly that the processes in steps S164, S170, and S171 are not performed and the emsg box in FIG. 18 is replaced with the emsg box in FIG. 20.

However, AveBandwidth and DurationForAveBandwidth are not described in the MPD file in the fifth embodiment. In addition, the profile described in the MPD file is a profile indicating that emsg in FIG. 20 is placed in the segment file and is, for example, “urn:mpeg:dash:profile:isoff-dynamic-bandwidth:2015”.

Furthermore, although illustration is omitted, the update process for AveBandwidth and DurationForAveBandwidth by a streaming reproduction unit 60 in the fifth embodiment is performed instead of the MPD file update process in the fourth embodiment. The update process for AveBandwidth and DurationForAveBandwidth is a process in which, when the emsg box in FIG. 20 is included in the media segment file acquired by a segment file acquisition unit 63, AveBandwidth and DurationForAveBandwidth are acquired from this emsg box and AveBandwidth and DurationForAveBandwidth are updated.

Additionally, the reproduction process of the streaming reproduction unit 60 in the fifth embodiment is the same as the reproduction process in FIG. 14, except that AveBandwidth out of the selection bit rates in step S111 is not supplied from an MPD processing unit 62 but is updated by a segment file acquisition unit 63 by itself. This reproduction process is performed in parallel with the update process for AveBandwidth and DurationForAveBandwidth.

As described thus far, in the fifth embodiment, since AveBandwidth and DurationForAveBandwidth are placed in the emsg box, it is unnecessary to analyze the MPD file every time AveBandwidth and DurationForAveBandwidth are updated.

Note that AveBandwidth and DurationForAveBandwidth may be periodically transmitted from the Web server 12 in compliance with another standard such as HTTP 2.0 and WebSocket, instead of being saved in the emsg box. Also in this case, similar effects to those of the fifth embodiment can be obtained.

In addition, in the fifth embodiment, the emsg box that saves therein the update notification information may be placed in the segment file, as in the third embodiment.

### Sixth Embodiment

(Description Example of MPD File)

A sixth embodiment of the information processing system to which the present disclosure is applied differs from the fifth embodiment mainly in that the XML data of AveBandwidth and DurationForAveBandwidth is placed in a segment file different from the segment file of the audio stream. Therefore, only the segment file that saves therein AveBandwidth and DurationForAveBandwidth (hereinafter referred to as band segment file), the file generation process, the update process for AveBandwidth and DurationForAveBandwidth, and the reproduction process will be described below.

FIG. 21 is a diagram illustrating a description example of the MPD file in the sixth embodiment.

Note that, for convenience of explanation, FIG. 21 illustrates only descriptions that manage the band segment file, among the descriptions in the MPD file.

As illustrated in FIG. 21, the adaptation set element of the band segment file differs from the adaptation set element of the audio stream in FIG. 4 in that the adaptation set element of the band segment file has <SupplementalProperty schemeIdUri=“urn:mpeg:dash:bandwidth:2015”>.

<SupplementalProperty schemeIdUri=“urn:mpeg:dash:bandwidth:2015”> is a descriptor indicating the update interval of the band segment file. As the value (value) of <SupplementalProperty schemeIdUri=“urn:mpeg:dash:bandwidth:2015”>, the update interval and file URL which is the base of the name of the band segment file are set. In the example in FIG. 21, the update interval is assigned as the reference duration ΔT and file URL is assigned as “$Bandwidth$bandwidth.info”. Therefore, the base of the name of the band segment file is obtained by adding “bandwidth” to Bandwidth included in the representation element.

In addition, in the example in FIG. 21, the maximum bit rates of three types of audio streams corresponding to the band segment files are 2.8 Mbps, 5.6 Mbps, and 11.2 Mbps. Therefore, the respective three representation elements have 2800000, 5600000, and 11200000 as Bandwidths. Accordingly, in the example in FIG. 21, the bases of the names of the band segment files are 2800000bandwidth.info, 5600000bandwidth.info, and 11200000bandwidth.info.

The segment information element included in the representation element has information relating to each band segment file of a band segment file group corresponding to this representation.

As described above, in the sixth embodiment, the update interval is described in the MPD file. Therefore, it is possible to easily modify the update frequency of AveBandwidth and DurationForAveBandwidth merely by modifying the update interval described in the MPD file and the update interval of the band segment file.

Note that, although illustration is omitted, the file generation process of a file generation device 11 in the sixth embodiment is similar to the file generation process in FIG. 12, except that the MPD file generated in step S60 is the MPD file in FIG. 21 and the MPD file is not updated but the band segment file is generated by a segment file generation unit 33 and uploaded to a Web server 12 via an upload unit 35 in step S69.

In addition, the update process for AveBandwidth and DurationForAveBandwidth by a streaming reproduction unit 60 in the sixth embodiment is similar to the MPD file update process in FIG. 13, except that a segment file acquisition unit 63 acquires the band segment file and updates AveBandwidth and DurationForAveBandwidth between steps S93 and S94 and the process returns to step S93 in a case where it is determined in step S94 that the process is not to be terminated.

Furthermore, the reproduction process of the streaming reproduction unit 60 in the sixth embodiment is the same as the reproduction process in FIG. 14, except that AveBandwidth out of the selection bit rates in step S111 is not supplied from an MPD processing unit 62 but is updated by the segment file acquisition unit 63 by itself. This reproduction process is performed in parallel with the update process for AveBandwidth and DurationForAveBandwidth.

As described thus far, in the sixth embodiment, since AveBandwidth and DurationForAveBandwidth are placed in the band segment file, it is unnecessary to analyze the MPD file every time AveBandwidth and DurationForAveBandwidth are updated.

### Seventh Embodiment

(First Description Example of MPD File)

A seventh embodiment of the information processing system to which the present disclosure is applied differs from the second embodiment in the configuration of the MPD file and in that the segment length of the audio stream is configured as being variable such that the actual bit rate of the segment file of the audio stream falls within a predetermined range. Therefore, only the configuration of the MPD file and the segment file will be described below.

FIG. 22 is a diagram illustrating a first description example of the MPD file in the seventh embodiment.

The description of the MPD file in FIG. 22 differs from the configuration in FIG. 10 in that the adaptation set element of the segment file of the audio stream has ConsecutiveSegmentInformation indicating the segment length of each segment file.

In the example in FIG. 22, the segment length changes by a positive multiple of the fixed segment length as a reference time. Specifically, the segment file is constituted by concatenating one or more segment files of a fixed segment length.

Therefore, as the value (Value) of ConsecutiveSegmentInformation, MaxConsecutiveNumber is described and thereafter FirstSegmentNumber and ConsecutiveNumbers are repeatedly described in order.

MaxConsecutiveNumber is information indicating the maximum number of concatenated segment files of a fixed segment length. The fixed segment length is set on the basis of timescale and duration of Segment Template included in the adaptation set element of the segment file of the audio stream. In the example in FIG. 22, timescale has 44100 and duration has 88200. Accordingly, the fixed segment length is two seconds.

FirstSegmentNumber is the number of segments from the top of a top segment of a group of consecutive segments having the same length, that is, a number included in the name of the top segment file of the group of the consecutive segment files having the same length of segment. ConsecutiveNumbers is information indicating how many times the fixed segment length the segment length of the segment group corresponding to immediately foregoing FirstSegmentNumber is.

In the example in FIG. 22, the value of ConsecutiveSegmentInformation is 2, 1, 1, 11, 2, 31, 1. Therefore, the maximum number of concatenations of the fixed segment length is two. In addition, a first media segment file from the top having a maximum bit rate of 2.8 Mbps and a file name of “2800000-1.mp4”, which corresponds to the representation element whose Bandwidth is 2800000, is obtained by concatenating one media segment file of the fixed segment length having a file name of “2800000-1.mp4”. Therefore, the segment length of the media segment file whose file name is “2800000-1.mp4” is two seconds which is once the fixed segment length.

Similarly, second to tenth media segment files from the top whose file names are “2800000-2.mp4” to “2800000-10.mp4” are also each obtained by concatenating one media segment file of the fixed segment length having file names of “2800000-2.mp4” to “2800000-10.mp4”, respectively, and the segment length thereof is two seconds.

Meanwhile, an eleventh media segment file from the top whose file name is “2800000-11.mp4” is obtained by concatenating two media segment files of the fixed segment length having file names of “2800000-11.mp4” and “2800000-12.mp4”. Therefore, the segment length of the media segment file whose file name is “2800000-11.mp4” is four seconds which is twice the fixed segment length. In addition, the file name “2800000-12.mp4” of the media segment file concatenated to the media segment file whose file name is “2800000-11.mp4” is skipped.

Similarly, twelfth to nineteenth media segment files from the top whose file names are “2800000-13.mp4”, “2800000-15.mp4”, . . . , and “2800000-29.mp4” are also each obtained by concatenating two media segment files of the fixed segment length and the segment length thereof is four seconds.

Furthermore, a twentieth media segment file from the top whose file name is “2800000-31.mp4” is obtained by concatenating one media segment file of the fixed segment length whose file name is “2800000-31.mp4”. Therefore, the segment length of the media segment file whose file name is “2800000-31.mp4” is two seconds which is once the fixed segment length.

Since the configuration of the media segment files having maximum bit rates of 5.6 Mbps and 11.2 Mbps, which correspond to the representation elements whose Bandwidths are U.S. Pat. Nos. 5,600,000 and 11,200,000, is similar to the configuration of the media segment file having a maximum bit rate of 2.8 Mbps, the explanation will be omitted.

(Second Description Example of MPD File)

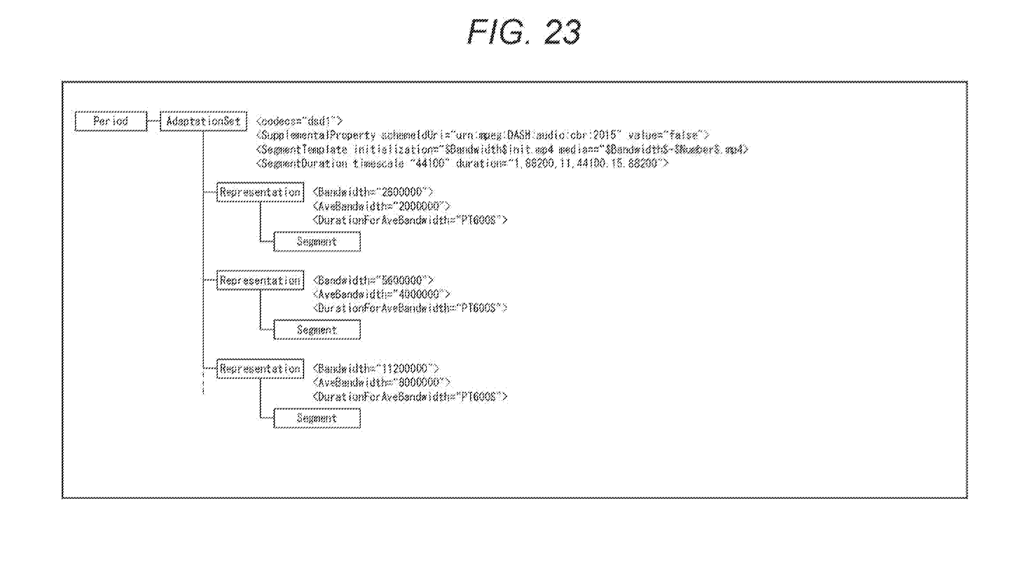

FIG. 23 is a diagram illustrating a second description example of the MPD file in the seventh embodiment.

The configuration of the MPD file in FIG. 23 differs from the configuration in FIG. 10 in that timescale and duration are not described in Segment Template and that the adaptation set element of the segment file of the audio stream has SegmentDuration.

In the example in FIG. 23, the segment length changes to an arbitrary time. Therefore, timescale and duration are described as SegmentDuration. timescale is a value representing one second and 44100 is set in the example in FIG. 23.

In addition, as for duration, FirstSegmentNumber and SegmentDuration are repeatedly described in order. FirstSegmentNumber is the same as FirstSegmentNumber in FIG. 22. SegmentDuration is the value of the segment length of the segment group corresponding to immediately foregoing FirstSegmentNumber when timescale is assumed as one second.

In the example in FIG. 23, the value of SegmentDuration is 1, 88200, 11, 44100, 15, 88200. Therefore, the segment length of a first media segment file from the top having a maximum bit rate of 2.8 Mbps and a file name of “2800000-1.mp4”, which corresponds to the representation element whose Bandwidth is 2800000, is two seconds (=88200/44100). Similarly, the segment lengths of second to tenth media segment files from the top whose file names are “2800000-2.mp4” to “2800000-10.mp4” are also two seconds.

Meanwhile, the segment length of an eleventh media segment file from the top whose file name is “2800000-11.mp4” is one second (=44100/44100). Similarly, the segment lengths of twelfth to fourteenth media segment files from the top whose file names are “2800000-12.mp4” to “2800000-14.mp4” are also one second.

Furthermore, the segment length of a fifteenth media segment file from the top whose file name is “2800000-15.mp4” is two seconds (=88200/44100).

Since the configuration of the media segment files having maximum bit rates of 5.6 Mbps and 11.2 Mbps, which correspond to the representation elements whose Bandwidths are U.S. Pat. Nos. 5,600,000 and 11,200,000, is similar to the configuration of the media segment file having a maximum bit rate of 2.8 Mbps, the explanation will be omitted.

As described above, in the example in FIG. 23, there is no skipped file name of the media segment file of the audio stream.

Note that, in the seventh embodiment, a segment file generation unit 33 decides the segment length on the basis of the actual bit rate or the average value of the actual bit rates of the audio stream such that this bit rate falls within a predetermined range. In addition, in the seventh embodiment, since the segment file is live-distributed, the segment length changes as the audio stream is being generated. Therefore, a moving image reproduction terminal 14 needs to acquire and update the MPD file every time the segment length is modified.

In the seventh embodiment, the modification timing of the segment length is assumed to be the same as the calculation timing of the average value of the actual bit rates of the audio stream, but may be made different. In a case where both of the timings differ from each other, information indicating the update interval and the update time of the segment length is transferred to the moving image reproduction terminal 14 and the moving image reproduction terminal 14 updates the MPD file on the basis of this information.

(Configuration Example of Segment File)

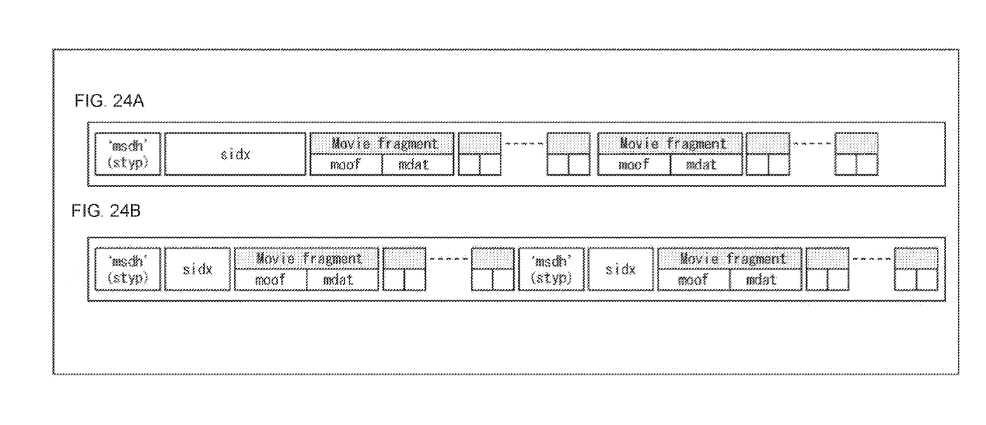

FIG. 24 is a diagram illustrating a configuration example of the media segment file of the audio stream by the lossless DSD technique in the seventh embodiment.

The configuration of the media segment file in A of FIG. 24 differs from the configuration in FIG. 15 in that there are Movie fragments equivalent not to a fixed segment length but to a variable segment length and that the emsg box is not provided.

Note that, in a case where the media segment file is constituted by concatenating one or more media segment files of a fixed segment length as in the example in FIG. 22, the media segment file may be constituted by simply concatenating one or more media segment files of a fixed segment length, as illustrated in B of FIG. 24. In this case, there are as many styp boxes and sidx boxes as the number of concatenated media segment files.

As described thus far, in the seventh embodiment, the segment length of the audio stream is configured as being variable such that the actual bit rate of the segment file of the audio stream falls within a predetermined range. Therefore, even in a case where the actual bit rate of the audio stream is small, the moving image reproduction terminal 14 can acquire the audio stream at a bit rate within a predetermined range by acquiring the segment file in units of segments.

In contrast to this, in a case where the segment length is fixed, a bit amount of the audio stream acquired by one time of acquisition of the segment file in units of segments decreases if the actual bit rate of the audio stream is small. As a result, the HTTP overhead per bit amount increases.

Note that the information indicating the segment length of each segment file may be transmitted to the moving image reproduction terminal 14, in a similar manner to AveBandwidth and DurationForAveBandwidth in the third to sixth embodiments. In addition, a file indicating the segment length of each segment file may be generated separately from the MPD file so as to be transmitted to the moving image reproduction terminal 14.

Furthermore, also in the third to sixth embodiments, the segment length may be configured as being variable, as in the seventh embodiment.

<Explanation of Lossless DSD Technique>

(Configuration Example of Lossless Compression Encoding Unit)

FIG. 25 is a block diagram illustrating a configuration example of a lossless compression encoding unit from the acquisition unit 31 and the encoding unit 32 in FIG. 3, which A/D-converts the audio analog signal to encode by the lossless DSD technique.

The lossless compression encoding unit 100 in FIG. 25 is constituted by an input unit 111, an ADC 112, an input buffer 113, a control unit 114, an encoder 115, an encoded data buffer 116, a data amount comparison unit 117, a data transmission unit 118, and an output unit 119. The lossless compression encoding unit 100 converts the audio analog signal into the audio digital signal by the DSD technique and losslessly compresses and encodes the converted audio digital signal to output.

Specifically, the audio analog signal of the moving image content is input from the input unit 111 and supplied to the ADC 112.

The ADC 112 is constituted by an adder 121, an integrator 122, a comparator 123, a one-sample delay circuit 124, and a one-bit DAC 125 and converts the audio analog signal into the audio digital signal by the DSD technique.

That is, the audio analog signal supplied from the input unit 111 is supplied to the adder 121. The adder 121 adds the audio analog signal of one sample duration earlier supplied from the one-bit DAC 125 and the audio analog signal from the input unit 111, to output to the integrator 122.

The integrator 122 integrates the audio analog signal from the adder 121 to output to the comparator 123. The comparator 123 performs one-bit quantization by comparing the integral value and the midpoint potential of the audio analog signal supplied from the integrator 122 at every sample duration.

Note that it is assumed in this example that the comparator 123 performs one-bit quantization, but the comparator 123 may perform two-bit quantization, four-bit quantization, or the like. In addition, for example, a frequency of 64 times or 128 times 48 kHz or 44.1 kHz is used as the frequency of the sample duration (sampling frequency). The comparator 123 outputs the one-bit audio digital signal obtained by one-bit quantization to the input buffer 113 and also supplies the one-bit audio digital signal to the one-sample delay circuit 124.

The one-sample delay circuit 124 delays the one-bit audio digital signal from the comparator 123 by one sample duration to output to the one-bit DAC 125. The one-bit DAC 125 converts the audio digital signal from the one-sample delay circuit 124 into the audio analog signal to output to the adder 121.

The input buffer 113 temporarily accumulates the one-bit audio digital signal supplied from the ADC 112 to supply to the control unit 114, the encoder 115, and the data amount comparison unit 117 on a frame-by-frame basis. Here, one frame is a unit regarded as one pack obtained by splitting the audio digital signal into a predetermined time (duration).

The control unit 114 controls the operation of the entire lossless compression encoding unit 100. The control unit 114 also has a function of creating a conversion table table1 required for the encoder 115 to perform lossless compression encoding and supplying the created conversion table table1 to the encoder 115.

Specifically, the control unit 114 creates a data production count table pre_table in units of frames using the audio digital signal of one frame supplied from the input buffer 113 and further creates the conversion table table1 from the data production count table pre_table. The control unit 114 supplies the conversion table table1 created in units of frames to the encoder 115 and the data transmission unit 118.

Using the conversion table table1 supplied from the control unit 114, the encoder 115 losslessly compresses and encodes the audio digital signal supplied from the input buffer 113 in units of four bits. Therefore, the audio digital signal is supplied to the encoder 115 from the input buffer 113 simultaneously with the timing of supply to the control unit 114. In the encoder 115, however, the process is put in a standby state until the conversion table table1 is supplied from the control unit 114.

Although the details of the lossless compression encoding will be described later, the encoder 115 losslessly compresses and encodes the four-bit audio digital signal into a two-bit audio digital signal or a six-bit audio digital signal to output to the encoded data buffer 116.

The encoded data buffer 116 temporarily buffers the audio digital signal generated as a result of the lossless compression encoding in the encoder 115 to supply to the data amount comparison unit 117 and the data transmission unit 118.

The data amount comparison unit 117 compares the data amount of the audio digital signal not subjected to the lossless compression encoding, which has been supplied from the input buffer 113, and the data amount of the audio digital signal subjected to the lossless compression encoding, which has been supplied from the encoded data buffer 116, in units of frames.

That is, as described above, since the encoder 115 losslessly compresses and encodes the four-bit audio digital signal into a two-bit audio digital signal or a six-bit audio digital signal, the data amount of the audio digital signal after the lossless compression encoding exceeds the data amount of the audio digital signal before the lossless compression encoding in some cases by algorithm. Thus, the data amount comparison unit 117 compares the data amount of the audio digital signal after the lossless compression encoding with the data amount of the audio digital signal before the lossless compression encoding.

Then, the data amount comparison unit 117 selects one with a smaller data amount and supplies selection control data indicating which one is selected to the data transmission unit 118. Note that, in the case of supplying the selection control data indicating that the audio digital signal before the lossless compression encoding has been selected to the data transmission unit 118, the data amount comparison unit 117 also supplies the audio digital signal before the lossless compression encoding to the data transmission unit 118.

On the basis of the selection control data supplied from the data amount comparison unit 117, the data transmission unit 118 selects either the audio digital signal supplied from the encoded data buffer 116 or the audio digital signal supplied from the data amount comparison unit 117. In the case of selecting the audio digital signal subjected to the lossless compression encoding, which has been supplied from the encoded data buffer 116, the data transmission unit 118 generates an audio stream from this audio digital signal, the selection control data, and the conversion table table1 supplied from the control unit 114. On the other hand, in the case of selecting the audio digital signal not subjected to the lossless compression encoding, which has been supplied from the data amount comparison unit 117, the data transmission unit 118 generates an audio stream from this audio digital signal and the selection control data. Then, the data transmission unit 118 outputs the generated audio stream via the output unit 119. Note that the data transmission unit 118 can also generate an audio stream by adding a synchronization signal and an error correction code (ECC) to an audio digital signal for each predetermined number of samples.

(Example of Data Production Count Table)

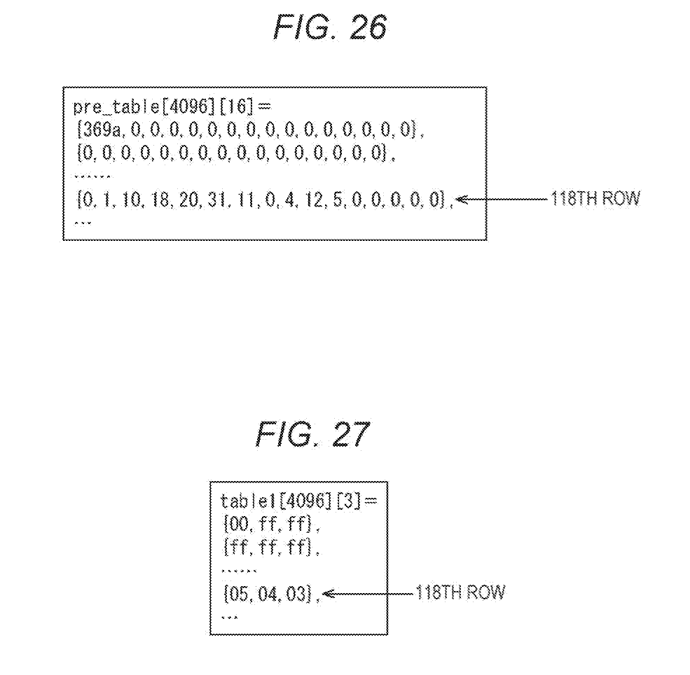

FIG. 26 is a diagram illustrating an example of the data production count table generated by the control unit 114 in FIG. 25.

The control unit 114 divides the audio digital signal in units of frames supplied from the input buffer 113 in units of four bits. Hereinafter, an i-th (i is an integer larger than one) divided audio digital signal in units of four bits from the top is referred to as D4 data D4[i].

The control unit 114 assigns n-th (n>3) D4 data D4[n] as current D4 data in order from the top for each frame. For each pattern of three pieces of past D4 data D4[n−3], D4[n−2], and D4[n−1] immediately preceding the current D4 data D4[n], the control unit 114 counts the number of times of production of the current D4 data D4[n] and creates the data production count table pre_table[4096][16] illustrated in FIG. 26. Here, [4096] and [16] of the data production count table pre_table[4096][16] represent that the data production count table is a table (matrix) of 4096 rows and 16 columns, where each of the rows [0] to [4095] corresponds to values that can be taken by the three pieces of past D4 data D4[n−3], D4[n−2], and D4[n−1] and each of the columns [0] to [15] corresponds to values that can be taken by the current D4 data D4[n].

Specifically, pre_table[0][0] to [0][15], which are in a first row of the data production count table pre_table, indicate the number of times of production of the current D4 data D4[n] when the three pieces of past D4 data D4[n−3], D4[n−2] and D4[n−1] were “0”={0000, 0000, 0000}. In the example in FIG. 26, the number of times that the three pieces of past D4 data D4[n−3], D4[n−2], and D4[n−1] were “0” and the current D4 data D4[n] was “0” is 369a (HEX notation) and the number of times that the three pieces of past D4 data D4[n−3], D4[n−2], and D4[n−1] were “0” and the D4 data D4[n] was a value other than “0” is zero. Therefore, pre_table[0][0] to [0][15] are written as {369a, 0, 0, 0, 0, 0, 0, 0, 0, 0, 0, 0, 0, 0, 0, 0}.

pre_table[1][0] to [1][15], which are in a second row of the data production count table pre_table, indicate the number of times of production of the current D4 data D4[n] when the three pieces of past D4 data D4[n−3], D4[n−2] and D4[n−1] were “1”={0000, 0000, 0001}. In the example in FIG. 26, there is no pattern in one frame in which the three pieces of past D4 data D4[n−3], D4[n−2], and D4[n−1] were “1”. Therefore, pre_table[1][0] to [1] [15] are written as {0, 0, 0, 0, 0, 0, 0, 0, 0, 0, 0, 0, 0, 0, 0, 0}.

In addition, pre_table[117][0] to [117][15], which are in a 118th row of the data production count table pre_table, indicate the number of times of production of the current D4 data D4[n] when the three pieces of past D4 data D4[n−3], D4[n−2] and D4[n−1] were “117”={0000, 0111, 0101}. The example in FIG. 26 indicates that, in a case where the three pieces of past D4 data D4[n−3], D4[n−2], D4[n−1] were “117”, the number of times that the current D4 data D4[n] was “0” is zero, the number of times that the current D4 data D4[n] was “1” is one, the number of times that the current D4 data D4[n] was “2” is ten, the number of times that the current D4 data D4[n] was “3” is 18, the number of times that the current D4 data D4[n] was “4” is 20, the number of times that the current D4 data D4[n] was “5” is 31, the number of times that the current D4 data D4[n] was “6” is 11, the number of times that the current D4 data D4[n] was “7” is zero, the number of times that the current D4 data D4[n] was “8” is four, the number of times that the current D4 data D4[n] was “9” is 12, the number of times that the current D4 data D4[n] was “10” is five, and the number of times that the current D4 data D4[n] was “11” to “15” is zero. Therefore, pre_table[117][0] to [117] [15] are written as {0, 1, 10, 18, 20, 31, 11, 0, 4, 12, 5, 0, 0, 0, 0, 0}.

(Example of Conversion Table)

FIG. 27 is a diagram illustrating an example of the conversion table table1 generated by the control unit 114 in FIG. 25.

The control unit 114 creates the conversion table table1[4096][3] of 4096 rows and 3 columns on the basis of the data production count table pre_table created previously. Here, each of the rows [0] to [4095] of the conversion table table1[4096][3] corresponds to values that can be taken by the three pieces of past D4 data D4[n−3], D4[n−2], and D4[n−1] and, among the 16 values that can be taken by the current D4 data D4[n], three values with higher production frequencies are saved in each of the columns [0] to [2]. A value having the highest (first) production frequency is saved in the first column [0] of the conversion table table1[4096][3], a value having the second production frequency is saved in the second column [1], and a value having the third production frequency is saved in the third column [2].

Specifically, in a case where the control unit 114 generates the conversion table table1[4096][3] on the basis of the data production count table pre_table in FIG. 26, table1[117][0] to [117][2], which is in the 118th row of the conversion table table1[4096][3], is written as {05, 04, 03}, as illustrated in FIG. 27. That is, in pre_table[117][0] to [117][15] in the 118th row of the data production count table pre_table in FIG. 26, the value having the highest (first) production frequency is “5” which was produced 31 times, the value having the second production frequency is “4” which was produced 20 times, and the value having the third production frequency is “3” which was produced 18 times. Therefore, in the conversion table table1[4096][3], {05} is saved in the 118th row of the first column table1[117][0], {04} is saved in the 118th row of the second column table1[117][1], and {03} is saved in the 118th row of the third column table1[117][2].

Similarly, table1[0][0] to [0][2] in the first row of the conversion table table1[4096][3] is generated on the basis of pre_table[0][0] to [0][15] in the first row of the data production count table pre_table in FIG. 26. That is, in pre_table[0][0] to [0][15] in the first row of the data production count table pre_table in FIG. 26, the value having the highest (first) production frequency is “0” which was produced 369a (HEX notation) times and no other value was produced. Thus, {00} is saved in the first row of the first column table1[0][0] of the conversion table table1[4096][3] and {ff} representing that there is no data is saved in the first row of the second column table1[0][1] and the first row of the third column table1[0][2]. The value representing that there is no data is not restricted to {ff} and can be decided as appropriate. Since the value saved in each element of the conversion table table1 is any one of “0” to “15”, the value can be expressed by four bits but is expressed by eight bits for ease of handling in computer processing.

(Explanation of Lossless Compression Encoding)

Next, a compression encoding method using the conversion table table1 by the encoder 115 in FIG. 25 will be explained.

Like the control unit 114, the encoder 115 divides the audio digital signal in units of frames supplied from the input buffer 113 in units of four bits. In the case of lossless compression encoding on the n-th D4 data D4[n] from the top, the control unit 114 searches for three values in a row corresponding to the immediately preceding three pieces of past D4 data D4[n−3], D4[n−2], and D4[n−1] in the conversion table table1[4096][3]. In a case where the D4 data D4[n] to be losslessly compressed and encoded has the same value as the value in the first column of the row corresponding to the immediately preceding three pieces of past D4 data D4[n−3], D4[n−2], and D4[n−1] in the conversion table table1[4096][3], the encoder 115 generates a two-bit value “01b” as a result of the lossless compression encoding on the D4 data D4[n]. In addition, in a case where the D4 data D4[n] to be losslessly compressed and encoded has the same value as the value in the second column of the row corresponding to the immediately preceding three pieces of past D4 data D4[n−3], D4[n−2], and D4[n−1] in the conversion table table1[4096][3], the encoder 115 generates a two-bit value “10b” as a result of the lossless compression encoding on the D4 data D4[n] and, in a case where the D4 data D4[n] has the same value as the value in the third column, the encoder 115 generates a two-bit value “11b” as a result of the lossless compression encoding on the D4 data D4[n].

On the other hand, in a case where there is no value same as the value of the D4 data D4[n] to be losslessly compressed and encoded among three values in the row corresponding to the immediately preceding three pieces of past D4 data D4[n−3], D4[n−2], and D4[n−1] in the conversion table table1[4096][3], the encoder 115 generates a six-bit value “00b+D4[n]” obtained by attaching “00b” before that D4 data D4[n], as a result of the lossless compression encoding on the D4 data D4[n]. Here, b in “01b”, “10b”, “11b”, “00b+D4[n]” represents that these values are in binary notation.

With the operation described above, the encoder 115 converts the four-bit DSD data D4[n] into the two-bit value “01b”, “10b”, or “11b” or into the six-bit value “00b+D4[n]” using the conversion table table1 to employ as the lossless compression encoding result. The encoder 115 outputs the lossless compression encoding result to the encoded data buffer 116 as the audio digital signal subjected to the lossless compression encoding.

(Configuration Example of Lossless Compression Decoding Unit>

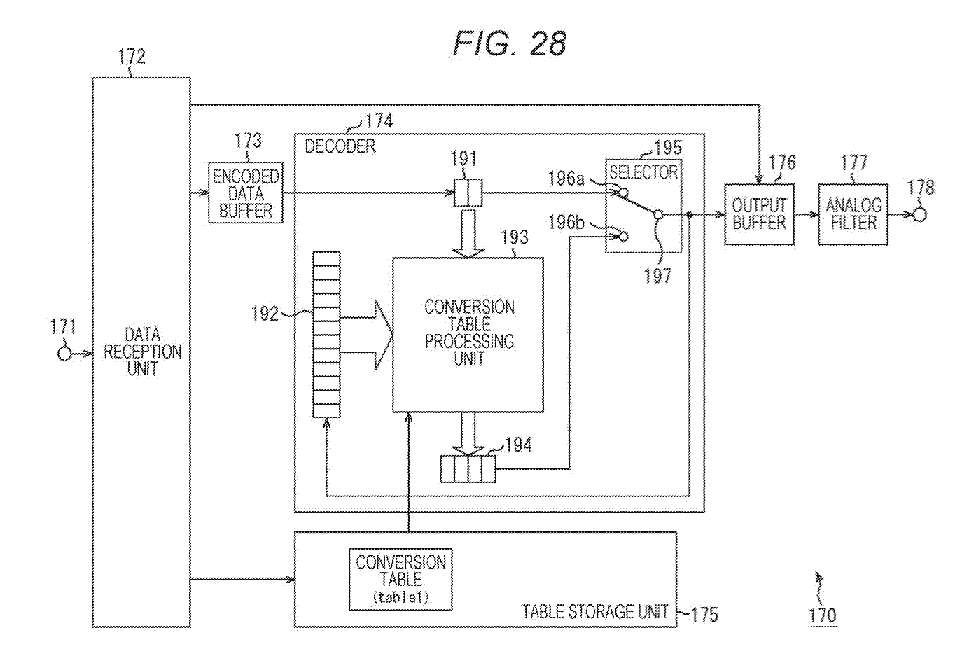

FIG. 28 is a block diagram illustrating a configuration example of a lossless compression decoding unit from the decoding unit 66 and the output control unit 67 in FIG. 7, which decodes the audio stream by the lossless DSD technique to D/A-convert.

The lossless compression decoding unit 170 in FIG. 28 is constituted by an input unit 171, a data reception unit 172, an encoded data buffer 173, a decoder 174, a table storage unit 175, an output buffer 176, an analog filter 177, and an output unit 178. The lossless compression decoding unit 170 losslessly compresses and decodes the audio stream by the lossless DSD technique and converts the audio digital signal obtained as a result of the lossless compression decoding into an audio analog signal by the DSD technique to output.

Specifically, the audio stream supplied from the buffer 65 in FIG. 7 is input from the input unit 171 and supplied to the data reception unit 172.

The data reception unit 172 determines whether or not the audio digital signal is losslessly compressed and encoded, on the basis of the selection control data indicating whether or not the audio digital signal included in the audio stream is losslessly compressed and encoded. Then, in a case where it is determined that the audio digital signal is losslessly compressed and encoded, the data reception unit 172 supplies the audio digital signal included in the audio stream to the encoded data buffer 173 as the audio digital signal subjected to the lossless compression encoding. The data reception unit 172 also supplies the conversion table table1 included in the audio stream to the table storage unit 175.

On the other hand, in a case where it is determined that the audio signal is not losslessly compressed and encoded, the data reception unit 172 supplies the audio digital signal included in the audio stream to the output buffer 176 as the audio digital signal not subjected to the lossless compression encoding.

The table storage unit 175 stores the conversion table table1 supplied from the data reception unit 172 to supply to the decoder 174.

The encoded data buffer 173 temporarily accumulates the audio digital signal subjected to the lossless compression encoding, which has been supplied from the data reception unit 172, in units of frames. The encoded data buffer 173 supplies the accumulated audio digital signals in units of frames to the decoder 174 in the succeeding stage by every two consecutive bits at a predetermined timing.

The decoder 174 is constituted by a two-bit register 191, a twelve-bit register 192, a conversion table processing unit 193, a four-bit register 194, and a selector 195. The decoder 174 losslessly compresses and decodes the audio digital signal subjected to the lossless compression encoding to generate an audio digital signal before the lossless compression encoding.

Specifically, the register 191 stores the two-bit audio digital signal supplied from the encoded data buffer 173. The register 191 supplies the stored two-bit audio digital signal to the conversion table processing unit 193 and the selector 195 at a predetermined timing.

The twelve-bit register 192 stores twelve bits of the four-bit audio digital signals supplied from the selector 195, which is a result of the lossless compression decoding, by first-in first-out (FIFO). With this operation, the register 192 saves therein D4 data which is immediately preceding three results of the past lossless compression decoding, among results of the lossless compression decoding on the audio digital signal including the two-bit audio digital signal stored in the register 191.

In a case where the two-bit audio digital signal supplied from the register 191 is “00b”, the conversion table processing unit 193 ignores this audio digital signal because it is not registered in the conversion table table1[4096][3]. The conversion table processing unit 193 also ignores the total of four-bit audio digital signal made up of the two-bit audio digital signals to be supplied twice immediately after the two-bit audio digital signal supplied most recently.

On the other hand, in a case where the supplied two-bit audio digital signal is “01b”, “10b”, or “11b”, the conversion table processing unit 193 reads the three pieces of D4 data (twelve-bit D4 data) stored in the register 192. The conversion table processing unit 193 reads, from the table storage unit 175, the D4 data saved in a column indicated by the supplied two-bit audio digital signal in a row in which the three pieces of read D4 data are registered as D4[n−3], D4[n−2], and D4[n−1] in the conversion table table1. The conversion table processing unit 193 supplies the read D4 data to the register 194.

The register 194 stores the four-bit D4 data supplied from the conversion table processing unit 193. The register 194 supplies the stored four-bit D4 data to an input terminal 196b of the selector 195 at a predetermined timing.

The selector 195 selects an input terminal 196a in a case where the two-bit audio digital signal supplied from the register 191 is “00b”. Then, the selector 195 outputs the four-bit audio digital signal input to the input terminal 196a after “00b” to the register 192 and the output buffer 176 through an output terminal 197 as a lossless compression decoding result.

On the other hand, in a case where the four-bit audio digital signal is input from the register 194 to the input terminal 196b, the selector 195 selects the input terminal 196b. Then, the selector 195 outputs the four-bit audio digital signal input to the input terminal 196b to the register 192 and the output buffer 176 through the output terminal 197 as a lossless compression decoding result.

The output buffer 176 stores the audio digital signal supplied from the data reception unit 172, which is not losslessly compressed and encoded, or the audio digital signal supplied from the decoder 174, which is a lossless compression decoding result, to supply to the analog filter 177.

The analog filter 177 executes a predetermined filtering process such as a low-pass filter and a band-pass filter on the audio digital signal supplied from the output buffer 176 and outputs the resultant signal via the output unit 178.

Note that the conversion table table1 may be compressed by the lossless compression encoding unit 100 to be supplied to the lossless compression decoding unit 170. In addition, the conversion table table1 may be set in advance so as to be stored in the lossless compression encoding unit 100 and the lossless compression decoding unit 170. Furthermore, a plurality of conversion tables table1 may be employed. In this case, in a j-th (j is an integer equal to or larger than zero) conversion table table1, 3(j−1)-th, 3(j−1)+1-th, and 3(j−1)+2-th pieces of D4 data from the highest production frequency is saved in each row. Additionally, the number of pieces of past D4 data corresponding to each row is not limited to three.

Meanwhile, the lossless compression encoding method is not limited to the above-described method and, for example, may be the method disclosed in Japanese Patent Application Laid-Open No. 9-74358.

### Eighth Embodiment

(Explanation of Computer to which Present Disclosure is Applied)

A series of the above-described processes can be executed by hardware as well and also can be executed by software. In a case where the series of the processes is executed by software, a program constituting the software is installed in a computer. Herein, the computer includes a computer built into dedicated hardware and a computer capable of executing various types of functions when installed with various types of programs, for example, a general-purpose personal computer or the like.

FIG. 29 is a block diagram illustrating a hardware configuration example of a computer that executes the above-described series of the processes using a program.

In the computer 200, a central processing unit (CPU) 201, a read only memory (ROM) 202, and a random access memory (RAM) 203 are interconnected through a bus 204.

Additionally, an input/output interface 205 is connected to the bus 204. An input unit 206, an output unit 207, a storage unit 208, a communication unit 209, and a drive 210 are connected to the input/output interface 205.

The input unit 206 includes a keyboard, a mouse, a microphone and the like. The output unit 207 includes a display, a speaker and the like. The storage unit 208 includes a hard disk, a non-volatile memory and the like. The communication unit 209 includes a network interface and the like. The drive 210 drives a removable medium 211 such as a magnetic disk, an optical disc, a magneto-optical disk, or a semiconductor memory.

In the computer 200 configured as described above, for example, the above-described series of the processes is performed in such a manner that the CPU 201 loads a program stored in the storage unit 208 to the RAM 203 via the input/output interface 205 and the bus 204 to execute.

For example, the program executed by the computer 200 (CPU 201) can be provided by being recorded in the removable medium 211 serving as a package medium or the like. In addition, the program can be provided via a wired or wireless transfer medium such as a local area network, the Internet, or digital satellite broadcasting.

In the computer 200, the program can be installed to the storage unit 208 via the input/output interface 205 by mounting the removable medium 211 in the drive 210. Furthermore, the program can be installed to the storage unit 208 via a wired or wireless transfer medium when received by the communication unit 209. As an alternative manner, the program can be installed to the ROM 202 or the storage unit 208 in advance.

Note that, the program executed by the computer 200 may be a program in which the processes are performed along the time series in line with the order described in the present description, or alternatively, may be a program in which the processes are performed in parallel or at a necessary timing, for example, when called.

In addition, in the present description, a system refers to a collection of a plurality of constituent members (e.g., devices and modules (parts)) and whether or not all the constituent members are arranged within the same cabinet is not regarded as important. Therefore, a plurality of devices accommodated in separate cabinets so as to be connected to one another via a network and one device of which a plurality of modules is accommodated within one cabinet are both deemed as systems.

Furthermore, the effects described in the present description merely serve as examples and not construed to be limited. There may be another effect.

Additionally, the embodiments according to the present disclosure are not limited to the aforementioned embodiments and various modifications can be made without departing from the scope of the present disclosure.

For example, the lossless DSD technique in the first to eighth embodiments may be a technique other than the lossless DSD technique as long as the technique is a lossless compression technique in which the bit production amount by lossless compression encoding cannot be predicted. For example, the lossless DSD technique in the first to eighth embodiments may be the free lossless audio codec (FLAC) technique, the Apple lossless audio codec (ALAC) technique, or the like. Also in the FLAC technique and the ALAC technique, the bit production amount fluctuates in accordance with the waveform of the audio analog signal, as in the lossless DSD technique. Note that the ratio of fluctuation varies depending on the technique.

In addition, the information processing system 10 according to the first to eighth embodiments may distribute the segment file on demand from all the segment files of the moving image content already stored in the Web server 12, instead of live-distributing the segment file.

In this case, in the second, third, and seventh embodiments, AveBandwidth described in the MPD file has the average value over the entire duration of the moving image content. Therefore, in the second and seventh embodiments, the moving image reproduction terminal 14 does not update the MPD file. In addition, in the third embodiment, the moving image reproduction terminal 14 updates the MPD file but the MPD file does not change before and after the update.

Additionally, in this case, the seventh embodiment may be configured such that, while the segment files of the fixed segment length are generated at the time of generating the segment file, the Web server 12 concatenates these segment files of the fixed segment length at the time of on-demand distribution to generate a segment file of a variable segment length and transmits the generated segment file to the moving image reproduction terminal 14.

Furthermore, the information processing system 10 according to the first to eighth embodiments may cause the Web server 12 to store the segment file of the moving image content part way through so as to thereafter perform near-live distribution in which distribution is started from the top segment file of this moving image content.

In this case, a process similar to the process for on-demand distribution is performed on the segment file already stored in the Web server 12 at the start of reproduction and a process similar to the case of live distribution is performed on the segment file not yet stored in the Web server 12 at the start of reproduction.

Meanwhile, in the fourth to sixth embodiments, AveBandwidth and DurationForAveBandwidth (updated values thereof) are placed in the segment file. Therefore, even in a case where there is time from when the segment file of the moving image content is generated to when the segment file is reproduced, as in the on-demand distribution or near-live distribution, the moving image reproduction terminal 14 cannot acquire latest AveBandwidth and DurationForAveBandwidth at the start of reproduction. Accordingly, when the segment file that saves therein AveBandwidth and DurationForAveBandwidth (updated values thereof) is transmitted, latest AveBandwidth and DurationForAveBandwidth may be re-saved therein. In this case, the moving image reproduction terminal 14 can recognize latest AveBandwidth and DurationForAveBandwidth at the start of reproduction.

In addition, in the second to seventh embodiments, only latest AveBandwidth and DurationForAveBandwidth are described in the MPD file or the segment file, but AveBandwidths and DurationForAveBandwidths for every arbitrary time may be enumerated. In this case, the moving image reproduction terminal 14 can perform fine-grained band control. Note that, in a case where the arbitrary time is invariable, only one DurationForAveBandwidth may be described.

Note that the present disclosure can be also configured as described below.

(1)

A file generation device including a generation unit that generates bit rate information representing a bit rate of an audio stream encoded by a lossless compression technique.

(2)

The file generation device according to (1) above, in which

the bit rate information includes an average value of the bit rates over a predetermined duration and the predetermined duration.

(3)

The file generation device according to (2) above, in which

the predetermined duration is increased by a reference duration at every reference duration, and

the generation unit updates the bit rate information at every reference duration.

(4)

The file generation device according to (3) above, in which

the bit rate information is included in a management file that manages the audio stream.

(5)

The file generation device according to (4) above, in which

the management file includes information indicating the reference duration.

(6)

The file generation device according to (3) above, in which

the generation unit generates update notification information that notifies an update time of the bit rate information.

(7)

The file generation device according to (6) above, in which

the update notification information is included in a file in which the audio stream is saved.

(8)

The file generation device according to (3), (6), or (7) above, in which

an initial value of the bit rate information is included in a management file that manages the audio stream, and

an updated value of the bit rate information is included in a file in which the audio stream is saved.

(9)

The file generation device according to (3) above, in which

the bit rate information is included in a file in which the audio stream is saved.

(10)

The file generation device according to (3) above, in which

the bit rate information is included in a file different from a file in which the audio stream is saved and managed by a management file that manages the audio stream.

(11)

The file generation device according to any one of (1) to (10) above, further including a segment file generation unit that transforms the audio stream into a file in units of segments, in which

a length of each segment is a multiple of a positive number of a reference time, and

the positive number is included in a management file that manages the audio stream.

(12)

The file generation device according to any one of (1) to (10) above, further including a segment file generation unit that transforms the audio stream into a file in units of segments, in which

a length of each segment is a predetermined time, and

information representing the predetermined time is included in a management file that manages the audio stream.

(13)

The file generation device according to any one of (1) to (12) above, in which

the lossless compression technique is a lossless direct stream digital (DSD) technique, a free lossless audio codec (FLAC) technique, or an Apple lossless audio codec (ALAC) technique.

(14)

A file generation method including a generation step of generating, by a file generation device, bit rate information representing a bit rate of an audio stream encoded by a lossless compression technique.

### REFERENCE SIGNS LIST

11 File generation device
13 Internet
14 Moving image reproduction terminal
33 Segment file generation unit
34 MPD file generation unit
63 Segment file acquisition unit
64 Selection unit

1. A file generation device comprising a generation unit that generates bit rate information representing a bit rate of an audio stream encoded by a lossless compression technique.

2. The file generation device according to claim 1, wherein
the bit rate information includes an average value of the bit rates over a predetermined duration and the predetermined duration.

3. The file generation device according to claim 2, wherein
the predetermined duration is increased by a reference duration at every reference duration, and
the generation unit updates the bit rate information at every reference duration.

4. The file generation device according to claim 3, wherein
the bit rate information is included in a management file that manages the audio stream.

5. The file generation device according to claim 4, wherein
the management file includes information indicating the reference duration.

6. The file generation device according to claim 3, wherein
the generation unit generates update notification information that notifies an update time of the bit rate information.

7. The file generation device according to claim 6, wherein
the update notification information is included in a file in which the audio stream is saved.

8. The file generation device according to claim 3, wherein
an initial value of the bit rate information is included in a management file that manages the audio stream, and
an updated value of the bit rate information is included in a file in which the audio stream is saved.

9. The file generation device according to claim 3, wherein
the bit rate information is included in a file in which the audio stream is saved.

10. The file generation device according to claim 3, wherein
the bit rate information is included in a file different from a file in which the audio stream is saved and managed by a management file that manages the audio stream.

11. The file generation device according to claim 1, further comprising a segment file generation unit that transforms the audio stream into a file in units of segments, wherein
a length of each segment is a multiple of a positive number of a reference time, and
the positive number is included in a management file that manages the audio stream.

12. The file generation device according to claim 1, further comprising a segment file generation unit that transforms the audio stream into a file in units of segments, wherein
a length of each segment is a predetermined time, and
information representing the predetermined time is included in a management file that manages the audio stream.

13. The file generation device according to claim 1, wherein
the lossless compression technique is a lossless direct stream digital (DSD) technique, a free lossless audio codec (FLAC) technique, or an Apple lossless audio codec (ALAC) technique.

14. A file generation method comprising a generation step of generating, by a file generation device, bit rate information representing a bit rate of an audio stream encoded by a lossless compression technique.
